(19) United States
(12) Patent Application Publication
(10) Pub. No.: US 2021/0185725 A1
(43) Pub. Date: Jun. 17, 2021

(54) DYNAMIC BACKOFF SELECTION FOR WLAN AIRTIME FAIRNNESS

(71) Applicant: QUALCOMM Incorporated, San Diego, CA (US)

(72) Inventors: Vinod BELUR RAMACHANDRA, Chennai (IN); Shishir GANESH, Udupi (IN)

(21) Appl. No.: 16/712,488

(22) Filed: Dec. 12, 2019

(51) Int. Cl. H04W 74/08; H04W 74/00

(52) U.S. Cl. CPC H04W 74/085; H04W 74/006

(57) ABSTRACT

This disclosure provides systems, methods and apparatus, including computer programs encoded on computer storage media, for medium access contention operations. In some implementations, a device initiates a countdown of a backoff counter associated with a medium access contention operation for transmitting uplink (UL) data on a shared wireless medium, detects a presence of downlink (DL) data on the shared wireless medium, determines whether the wireless communication device is an intended recipient of the DL data, and adjusts the backoff counter based on the determination.

### TECHNICAL FIELD

This disclosure relates generally to wireless networks, and more specifically, to medium access contention operations on a shared wireless medium.

### DESCRIPTION OF THE RELATED TECHNOLOGY

A wireless local area network (WLAN) may be formed by one or more access points (APs) that provide a shared wireless communication medium for use by a number of client devices also referred to as stations (STAs). The basic building block of a WLAN conforming to the Institute of Electrical and Electronics Engineers (IEEE) 802.11 family of standards is a Basic Service Set (BSS), which is managed by an AP. Each BSS is identified by a Basic Service Set Identifier (BSSID) that is advertised by the AP. An AP periodically broadcasts beacon frames to enable any STAs within wireless range of the AP to establish or maintain a communication link with the WLAN.

Many wireless networks use random channel access mechanisms to control access to a shared wireless medium. In these wireless networks, wireless communication devices (including APs and STAs) contend with each other to gain access to the wireless medium. The wireless communication device that wins the contention operation becomes the owner of a transmission opportunity (TXOP) and may use the wireless medium for a duration of the TXOP. Other wireless communication devices are generally not permitted to transmit during the TXOP to prevent interference with transmissions from the TXOP owner.

### SUMMARY

The systems, methods and devices of this disclosure each have several innovative aspects, no single one of which is solely responsible for the desirable attributes disclosed herein.

One innovative aspect of the subject matter described in this disclosure can be implemented in a method for wireless communication. The method may be performed by a wireless communication device, and may include initiating a countdown of a backoff counter associated with a medium access contention operation for transmitting uplink (UL) data on a shared wireless medium, detecting a presence of downlink (DL) data on the shared wireless medium, determining whether the wireless communication device is an intended recipient of the DL data, and adjusting the backoff counter based on the determination. In some implementations, adjusting the backoff counter based on the determination includes resetting the backoff counter to an initial value in response to determining that the wireless communication device is an intended recipient of the DL data. In some other implementations, adjusting the backoff counter based on the determination includes not adjusting the backoff counter in response to determining that the wireless communication device is not an intended recipient of the DL data. The method may also include stopping the countdown of the backoff counter in response to detecting the presence of the DL data, and continuing, during a next medium access contention operation, the countdown of the backoff counter from where it was stopped.

In some implementations, the method may also include receiving an indication of a contention window size to be used for one or more UL medium access contention operations, selecting a random backoff number from the indicated contention window size, and setting an initial value of the backoff counter based on the selected random backoff number. In some other implementations, the method may also include receiving, from an access point (AP), one or more beacon frames including the indicated contention window size.

In some implementations, the indicated contention window size may be based on one or more of a number of collisions on the shared wireless medium, an amount of traffic on the shared wireless medium, or a level of contention on the shared wireless medium. In addition, or in the alternative, the indicated contention window size may be based on a relationship between DL throughput and UL throughput on the shared wireless medium.

Another innovative aspect of the subject matter described in this disclosure can be implemented in a wireless communication device. In some implementations, the wireless communication device may include at least one modem, at least one processor communicatively coupled with the at least one modem, and at least one memory communicatively coupled with the at least one processor. The memory stores processor-readable code that, when executed by the at least one processor in conjunction with the at least one modem, causes the wireless communication device to perform one or more operations. In some implementations, the one or more operations may include initiating a countdown of a backoff counter associated with a medium access contention operation for transmitting uplink (UL) data on a shared wireless medium, detecting a presence of downlink (DL) data on the shared wireless medium, determining whether the wireless communication device is an intended recipient of the DL data, and adjusting the backoff counter based on the determination. In some implementations, adjusting the backoff counter based on the determination includes resetting the backoff counter to an initial value in response to determining that the wireless communication device is an intended recipient of the DL data. In some other implementations, adjusting the backoff counter based on the determination includes not adjusting the backoff counter in response to determining that the wireless communication device is not an intended recipient of the DL data. The one or more operations may also include stopping the countdown of the backoff counter in response to detecting the presence of the DL data, and continuing, during a next medium access contention operation, the countdown of the backoff counter from where it was stopped.

In some implementations, the one or more operations may also include receiving an indication of a contention window size to be used for one or more UL medium access contention operations, selecting a random backoff number from the indicated contention window size, and setting an initial value of the backoff counter based on the selected random backoff number. In some other implementations, the one or more operations may also include receiving, from an access point (AP), one or more beacon frames including the indicated contention window size. The indicated contention window size may be proportional to a number of devices associated with the AP.

In some implementations, the indicated contention window size may be based on one or more of a number of collisions on the shared wireless medium, an amount of traffic on the shared wireless medium, or a level of contention on the shared wireless medium. In addition, or in the alternative, the indicated contention window size may be based on a relationship between DL throughput and UL throughput on the shared wireless medium.

Another innovative aspect of the subject matter described in this disclosure can be implemented in a method for wireless communication. The method may be performed by a wireless communication device, and may include receiving an indication of a contention window size to be used for one or more medium access contention operations, selecting a random backoff number from the indicated contention window size, setting an initial value of the backoff counter based on the selected random backoff number, and contending for medium access, based on a countdown of the backoff counter, to transmit uplink (UL) data on the shared wireless medium. In some implementations, the indicated contention window size may be based on one or more of a number of collisions on the shared wireless medium, an amount of traffic on the shared wireless medium, or a level of contention on the shared wireless medium. The method may also include receiving, from an access point (AP), one or more beacon frames including the indicated contention window size.

In some implementations, contending for medium access may include initiating the countdown of the backoff counter, detecting a presence of downlink (DL) data on the shared wireless medium, determining whether the wireless communication device is an intended recipient of the DL data, and adjusting the backoff counter based on the determination. In some implementations, adjusting the backoff counter based on the determination includes resetting the backoff counter to an initial value in response to determining that the wireless communication device is an intended recipient of the DL data. In some other implementations, adjusting the backoff counter based on the determination includes not adjusting the backoff counter in response to determining that the wireless communication device is not an intended recipient of the DL data. In addition, or in the alternative, the method may also include stopping the countdown of the backoff counter in response to detecting the presence of the DL data, and continuing, during a next medium access contention operation, the countdown of the backoff counter from where it was stopped.

Another innovative aspect of the subject matter described in this disclosure can be implemented in a wireless communication device. In some implementations, the wireless communication device may include at least one modem, at least one processor communicatively coupled with the at least one modem, and at least one memory communicatively coupled with the at least one processor. The memory stores processor-readable code that, when executed by the at least one processor in conjunction with the at least one modem, causes the wireless communication device to perform one or more operations. In some implementations, the one or more operations may include receiving an indication of a contention window size to be used for one or more medium access contention operations, selecting a random backoff number from the indicated contention window size, setting an initial value of the backoff counter based on the selected random backoff number, and contending for medium access, based on a countdown of the backoff counter, to transmit uplink (UL) data on the shared wireless medium. In some implementations, the indicated contention window size may be based on one or more of a number of collisions on the shared wireless medium, an amount of traffic on the shared wireless medium, or a level of contention on the shared wireless medium. The one or more operations may also include receiving, from an access point (AP), one or more beacon frames including the indicated contention window size.

In some implementations, contending for medium access may include initiating the countdown of the backoff counter, detecting a presence of downlink (DL) data on the shared wireless medium, determining whether the wireless communication device is an intended recipient of the DL data, and adjusting the backoff counter based on the determination. In some implementations, adjusting the backoff counter based on the determination includes resetting the backoff counter to an initial value in response to determining that the wireless communication device is an intended recipient of the DL data. In some other implementations, adjusting the backoff counter based on the determination includes not adjusting the backoff counter in response to determining that the wireless communication device is not an intended recipient of the DL data. In addition, or in the alternative, the one or more operations may also include stopping the countdown of the backoff counter in response to detecting the presence of the DL data, and continuing, during a next medium access contention operation, the countdown of the backoff counter from where it was stopped.

### BRIEF DESCRIPTION OF THE DRAWINGS

Details of one or more implementations of the subject matter described in this disclosure are set forth in the accompanying drawings and the description below. Other features, aspects, and advantages will become apparent from the description, the drawings and the claims. Note that the relative dimensions of the following figures may not be drawn to scale.

FIG. 1 shows a pictorial diagram of an example wireless communication network.

FIG. 2A shows an example protocol data unit (PDU) usable for communications between an access point (AP) and a number of stations (STAs).

FIG. 2B shows an example field in the PDU of FIG. 2A.

FIG. 3A shows an example physical layer (PHY) preamble usable for communications between an AP and each of a number of STAs.

FIG. 3B shows another example PHY preamble usable for communications between an AP and each of a number of stations.

FIG. 4 shows an example physical layer convergence protocol (PLCP) protocol data unit (PPDU) usable for communications between an AP and a number of STAs.

FIG. 5 shows a block diagram of an example wireless communication device.

FIG. 6A shows a block diagram of an example AP.

FIG. 6B shows a block diagram of an example STA.

FIG. 7 shows a timing diagram illustrating the transmissions of communications according to some implementations.

FIG. 8 shows a timing diagram illustrating the transmissions of communications according to some implementations.

FIG. 9 shows a sequence diagram illustrating the transmissions of communications according to other implementations.

FIG. 10 shows a flowchart illustrating an example process for wireless communication according to some implementations.

FIG. 11A shows a flowchart illustrating an example process for wireless communication according to some implementations.

FIG. 11B shows a flowchart illustrating an example process for wireless communication according to some implementations.

FIG. 11C shows a flowchart illustrating an example process for wireless communication according to some implementations.

FIG. 12 shows a flowchart illustrating an example process for wireless communication according to some implementations.

FIG. 13 shows a block diagram of an example wireless communication device according to some implementations.

FIG. 14 shows a block diagram of another example wireless communication device according to some implementations.

Like reference numbers and designations in the various drawings indicate like elements.

### DETAILED DESCRIPTION

The following description is directed to some particular implementations for the purposes of describing innovative aspects of this disclosure. However, a person having ordinary skill in the art will readily recognize that the teachings herein can be applied in a multitude of different ways. The described implementations can be implemented in any device, system, or network that is capable of transmitting and receiving radio frequency (RF) signals according to one or more of the Institute of Electrical and Electronics Engineers (IEEE) 802.11 standards, the IEEE 802.15 standards, the Bluetooth® standards as defined by the Bluetooth Special Interest Group (SIG), or the Long Term Evolution (LTE), 3G, 4G, or 5G (New Radio (NR)) standards promulgated by the 3rd Generation Partnership Project (3GPP), among others. The described implementations can be implemented in any device, system, or network that is capable of transmitting and receiving RF signals according to one or more of the following technologies or techniques: code division multiple access (CDMA), time division multiple access (TDMA), frequency division multiple access (FDMA), orthogonal FDMA (OFDMA), single-carrier FDMA (SC-FDMA), single-user (SU) multiple-input multiple-output (MIMO), and multi-user (MU) MIMO. The described implementations also can be implemented using other wireless communication protocols or RF signals suitable for use in one or more of a wireless personal area network (WPAN), a wireless local area network (WLAN), a wireless wide area network (WWAN), or an internet of things (TOT) network.

Various implementations relate generally to medium access contention operations on a shared wireless medium. Some implementations more specifically relate to maintaining a balance between downlink (DL) and uplink (UL) throughput in a wireless network based on one or more of detection of an increase in UL traffic relative to DL traffic in the wireless network, detection of an increase in the level of contention in the wireless network, or detection of an increase in the number of collisions in the wireless network.

In some implementations, a wireless communication device contending for medium access to transmit UL data on a shared wireless medium may detect a presence of downlink (DL) data on the shared wireless medium, and may adjust its backoff counter based on whether the wireless communication device is an intended recipient of the DL data. The wireless communication device may not adjust the backoff counter when it is not the intended recipient of the DL data, and the wireless communication device may adjust the backoff counter when it is one of the intended recipients of the DL data. In some implementations, not adjusting the backoff counter may include stopping the countdown of the backoff counter in response to detecting the presence of the DL data, and continuing, during a next medium access contention operation, the countdown of the backoff counter from where it was stopped. In some implementations, adjusting the backoff counter may include resetting the backoff counter to an initial value in response to receiving the DL data.

In other implementations, an AP may indicate a contention window size to be used by one or more associated wireless communication devices for medium access contention operations. The indicated contention window size may be based on one or more of a number of collisions on the shared wireless medium, an amount of traffic on the shared wireless medium, or a level of contention on the shared wireless medium. For example, in response to detecting an increase in the number of actively associated wireless communication devices, the AP may indicate a larger contention window size from which the wireless communication devices are to randomly select their backoff numbers.

Particular implementations of the subject matter described in this disclosure can be implemented to realize one or more of the following potential advantages. By resetting the backoff counter to an initial value in response to receiving DL data, rather than pausing the backoff counter, a wireless communication device may have a longer backoff period during one or more subsequent medium access contention operations on a wireless medium, thereby decreasing a likelihood of the wireless communication device obtaining a transmit opportunity (TXOP) to transmit UL data on the wireless medium during the one or more subsequent medium access contention operations. Reducing or at least delaying UL transmissions from wireless communication devices that also received DL data may decrease the amount of UL traffic relative to the amount of DL traffic, and thereby reduce asymmetries between UL and DL throughput on the wireless medium. As such, implementations of the subject matter described in this disclosure may be used to increase the symmetry between UL and DL throughput on the wireless medium, for example, to increase the number of traffic flows having substantially symmetrical UL and DL traffic (such as voice and video calls) that can be supported by a wireless network that includes a given number of associated wireless communication devices (such as STAs).

In addition, the ability to indicate or modify a contention window size to be used by one or more wireless communication devices for medium access contention operations may allow the AP to at least partially determine or adjust the contention backoff periods of the wireless communication devices, and therefore at least partially determine or adjust a likelihood of the wireless communication devices winning a particular medium access contention operation and transmitting UL data during a corresponding TXOP. For example, in response to detecting an imbalance between UL and DL throughput, the AP may indicate a larger contention window size to be used by the wireless communication devices. Increasing the range of numbers from which the wireless communication devices randomly select backoff numbers for their backoff counters may result in an increased average backoff counter value, and as such, may decrease a likelihood of the wireless communication devices obtaining a TXOP for UL transmissions in a given medium access contention operation.

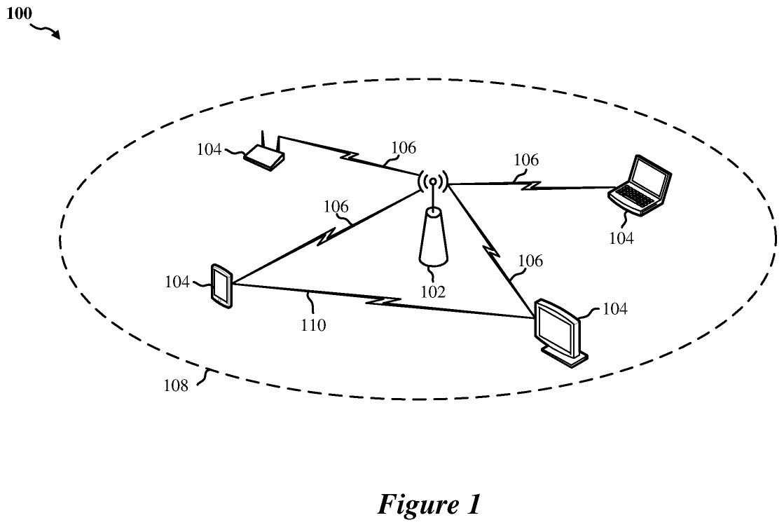

FIG. 1 shows a block diagram of an example wireless communication network 100. According to some aspects, the wireless communication network 100 can be an example of a wireless local area network (WLAN) such as a Wi-Fi network (and will hereinafter be referred to as WLAN 100). For example, the WLAN 100 can be a network implementing at least one of the IEEE 802.11 family of wireless communication protocol standards (such as that defined by the IEEE 802.11-2016 specification or amendments thereof including, but not limited to, 802.11ah, 802.11ad, 802.11ay, 802.11ax, 802.11az, 802.11ba, and 802.11be). The WLAN 100 may include numerous wireless communication devices such as an access point (AP) 102 and multiple stations (STAs) 104. While only one AP 102 is shown, the WLAN network 100 also can include multiple APs 102.

Each of the STAs 104 also may be referred to as a mobile station (MS), a mobile device, a mobile handset, a wireless handset, an access terminal (AT), a user equipment (UE), a subscriber station (SS), or a subscriber unit, among other possibilities. The STAs 104 may represent various devices such as mobile phones, personal digital assistants (PDAs), other handheld devices, netbooks, notebook computers, tablet computers, laptops, display devices (for example, TVs, computer monitors, navigation systems, among others), music or other audio or stereo devices, remote control devices (“remotes”), printers, kitchen or other household appliances, key fobs (for example, for passive keyless entry and start (PKES) systems), among other possibilities.

A single AP 102 and an associated set of STAs 104 may be referred to as a basic service set (BSS), which is managed by the respective AP 102. FIG. 1 additionally shows an example coverage area 108 of the AP 102, which may represent a basic service area (BSA) of the WLAN 100. The BSS may be identified to users by a service set identifier (SSID), as well as to other devices by a basic service set identifier (BSSID), which may be a medium access control (MAC) address of the AP 102. The AP 102 periodically broadcasts beacon frames (“beacons”) including the BSSID to enable any STAs 104 within wireless range of the AP 102 to “associate” or re-associate with the AP 102 to establish a respective communication link 106 (hereinafter also referred to as a “Wi-Fi link”), or to maintain a communication link 106, with the AP 102. For example, the beacons can include an identification of a primary channel used by the respective AP 102 as well as a timing synchronization function for establishing or maintaining timing synchronization with the AP 102. The AP 102 may provide access to external networks to various STAs 104 in the WLAN via respective communication links 106.

To establish a communication link 106 with an AP 102, each of the STAs 104 is configured to perform passive or active scanning operations (“scans”) on frequency channels in one or more frequency bands (for example, the 2.4 GHz, 5 GHz, 6 GHz, or 60 GHz bands). To perform passive scanning, a STA 104 listens for beacons, which are transmitted by respective APs 102 at a periodic time interval referred to as the target beacon transmission time (TBTT) (measured in time units (TUs) where one TU may be equal to 1024 microseconds (μs)). To perform active scanning, a STA 104 generates and sequentially transmits probe requests on each channel to be scanned and listens for probe responses from APs 102. Each STA 104 may be configured to identify or select an AP 102 with which to associate based on the scanning information obtained through the passive or active scans and to perform authentication and association operations to establish a communication link 106 with the selected AP 102. The AP 102 assigns an association identifier (AID) to the STA 104 at the culmination of the association operations, which the AP 102 uses to track the STA 104.

As a result of the increasing ubiquity of wireless networks, a STA 104 may have the opportunity to select one of many BSSs within range of the STA or to select among multiple APs 102 that together form an extended service set (ESS) including multiple connected BSSs. An extended network station associated with the WLAN 100 may be connected to a wired or wireless distribution system that may allow multiple APs 102 to be connected in such an ESS. As such, a STA 104 can be covered by more than one AP 102 and can associate with different APs 102 at different times for different transmissions. Additionally, after association with an AP 102, a STA 104 also may be configured to periodically scan its surroundings to find a more suitable AP 102 with which to associate. For example, a STA 104 that is moving relative to its associated AP 102 may perform a “roaming” scan to find another AP 102 having more desirable network characteristics such as a greater received signal strength indicator (RSSI) or a reduced traffic load.

In some cases, STAs 104 may form networks without APs 102 or other equipment other than the STAs 104 themselves. One example of such a network is an ad hoc network (or wireless ad hoc network). Ad hoc networks may alternatively be referred to as mesh networks or peer-to-peer (P2P) networks. In some cases, ad hoc networks may be implemented within a larger wireless network such as the WLAN 100. In such implementations, while the STAs 104 may be capable of communicating with each other through the AP 102 using communication links 106, STAs 104 also can communicate directly with each other via direct wireless links 110. Additionally, two STAs 104 may communicate via a direct communication link 110 regardless of whether both STAs 104 are associated with and served by the same AP 102. In such an ad hoc system, one or more of the STAs 104 may assume the role filled by the AP 102 in a BSS. Such a STA 104 may be referred to as a group owner (GO) and may coordinate transmissions within the ad hoc network. Examples of direct wireless links 110 include Wi-Fi Direct connections, connections established by using a Wi-Fi Tunneled Direct Link Setup (TDLS) link, and other P2P group connections.

The APs 102 and STAs 104 may function and communicate (via the respective communication links 106) according to the IEEE 802.11 family of wireless communication protocol standards (such as that defined by the IEEE 802.11-2016 specification or amendments thereof including, but not limited to, 802.11ah, 802.11ad, 802.11ay, 802.11ax, 802.11az, 802.11ba, and 802.11be). These standards define the WLAN radio and baseband protocols for the PHY and medium access control (MAC) layers. The APs 102 and STAs 104 transmit and receive wireless communications (hereinafter also referred to as “Wi-Fi communications”) to and from one another in the form of physical layer convergence protocol (PLCP) protocol data units (PPDUs). The APs 102 and STAs 104 in the WLAN 100 may transmit PPDUs over an unlicensed spectrum, which may be a portion of spectrum that includes frequency bands traditionally used by Wi-Fi technology, such as the 2.4 GHz band, the 5 GHz band, the 60 GHz band, the 3.6 GHz band, and the 900 MHz band. Some implementations of the APs 102 and STAs 104 described herein also may communicate in other frequency bands, such as the 6 GHz band, which may support both licensed and unlicensed communications. The APs 102 and STAs 104 also can be configured to communicate over other frequency bands such as shared licensed frequency bands, where multiple operators may have a license to operate in the same or overlapping frequency band or bands.

Each of the frequency bands may include multiple sub-bands or frequency channels. For example, PPDUs conforming to the IEEE 802.11n, 802.11ac, and 802.11ax standard amendments may be transmitted over the 2.4 and 5 GHz bands, each of which is divided into multiple 20 MHz channels. As such, these PPDUs are transmitted over a physical channel having a minimum bandwidth of 20 MHz, but larger channels can be formed through channel bonding. For example, PPDUs may be transmitted over physical channels having bandwidths of 40 MHz, 80 MHz, 160 MHz, or 320 MHz by bonding together multiple 20 MHz channels.

Each PPDU is a composite structure that includes a PHY preamble and a payload in the form of a PLCP service data unit (PSDU). The information provided in the preamble may be used by a receiving device to decode the subsequent data in the PSDU. In instances in which PPDUs are transmitted over a bonded channel, the preamble fields may be duplicated and transmitted in each of the multiple component channels. The PHY preamble may include both a legacy portion (or “legacy preamble”) and a non-legacy portion (or “non-legacy preamble”). The legacy preamble may be used for packet detection, automatic gain control, and channel estimation, among other uses. The legacy preamble also may generally be used to maintain compatibility with legacy devices. The format of, coding of, and information provided in the non-legacy portion of the preamble is based on the particular IEEE 802.11 protocol to be used to transmit the payload.

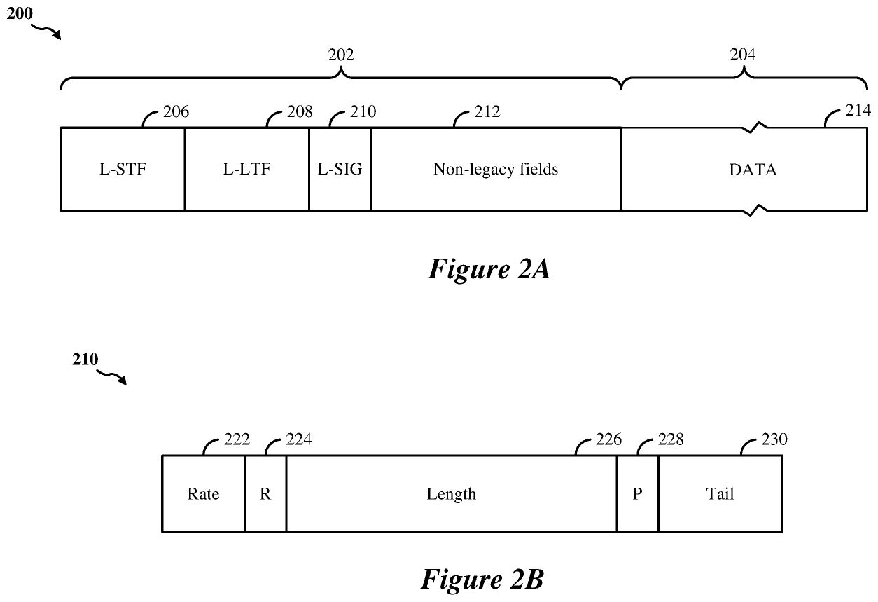

FIG. 2A shows an example protocol data unit (PDU) 200 usable for wireless communication between an AP and a number of STAs. For example, the PDU 200 can be configured as a PPDU. As shown, the PDU 200 includes a PHY preamble 202 and a PHY payload 204. For example, the preamble 202 may include a legacy portion that itself includes a legacy short training field (L-STF) 206, which may consist of two binary phase shift keying (BPSK) symbols, a legacy long training field (L-LTF) 208, which may consist of two BPSK symbols, and a legacy signal field (L-SIG) 210, which may consist of two BPSK symbols. The legacy portion of the preamble 202 may be configured according to the IEEE 802.11a wireless communication protocol standard. The preamble 202 also may include a non-legacy portion including one or more non-legacy fields 212, for example, conforming to an IEEE wireless communication protocol, such as the IEEE 802.11ac, 802.11ax, 802.11be, or later wireless communication protocol standards.

The L-STF 206 generally enables a receiving device to perform automatic gain control (AGC) and coarse timing and frequency estimation. The L-LTF 208 generally enables a receiving device to perform fine timing and frequency estimation and also to estimate of the wireless channel. The L-SIG 210 generally enables a receiving device to determine a duration of the PDU and to use the determined duration to avoid transmitting on top of the PDU. For example, the L-STF 206, the L-LTF 208, and the L-SIG 210 may be modulated according to a BPSK modulation scheme. The payload 204 may be modulated according to a BPSK modulation scheme, a quadrature BPSK (Q-BPSK) modulation scheme, a quadrature amplitude modulation (QAM) scheme, or another appropriate modulation scheme. The payload 204 may generally carry higher layer data, for example, in the form of medium access control (MAC) protocol data units (MPDUs) or aggregated MPDUs (A-MPDUs).

FIG. 2B shows an example L-SIG 210 in the PDU 200 of FIG. 2A. The L-SIG 210 includes a data rate field 222, a reserved bit 224, a length field 226, a parity bit 228, and a tail field 230. The data rate field 222 indicates a data rate (note that the data rate indicated in the data rate field 222 may not be the actual data rate of the data carried in the payload 204). The length field 226 indicates a length of the packet in units of, for example, symbols or bytes. The parity bit 228 may be used to detect bit errors. The tail field 230 includes tail bits that may be used by the receiving device to terminate operation of a decoder (for example, a Viterbi decoder). The receiving device may utilize the data rate and the length indicated in the data rate field 222 and the length field 226 to determine a duration of the packet in units of, for example, microseconds (μs) or other time units.

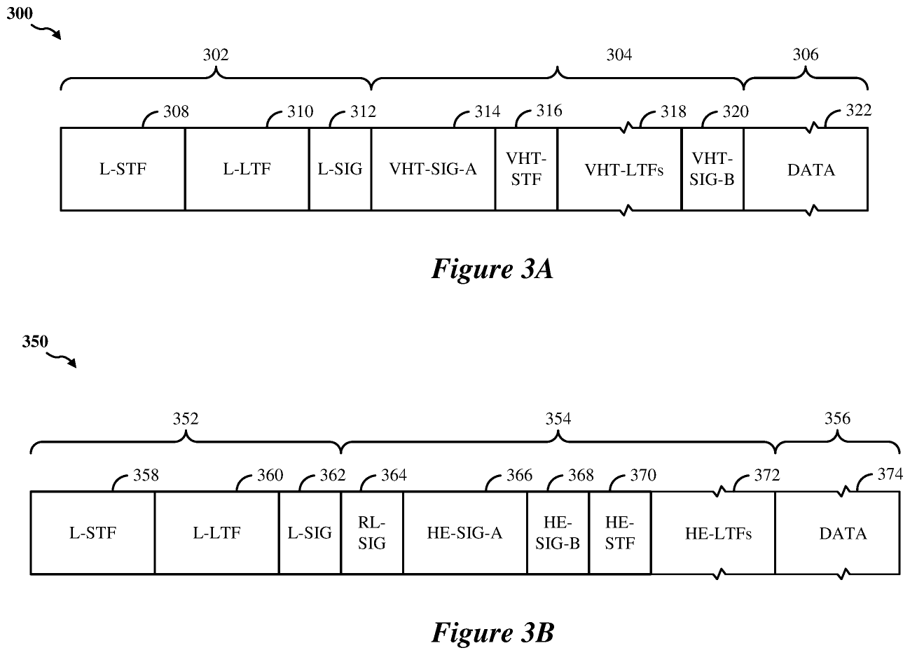

FIG. 3A shows another example PDU 300 usable for wireless communication between an AP and a number of STAs. The PDU 300 includes a PHY preamble including a legacy portion 302 and a non-legacy portion 304. The PDU 300 may further include a PHY payload 306 after the preamble, for example, in the form of a PSDU including a DATA field 322. The legacy portion 302 of the preamble includes L-STF 308, L-LTF 310, and L-SIG 312. The non-legacy portion 304 of the preamble and the DATA field 322 may be formatted as a Very High Throughput (VHT) preamble and frame, respectively, in accordance with the IEEE 802.11ac amendment to the IEEE 802.11 wireless communication protocol standard. The non-legacy portion 304 includes a first VHT signal field (VHT-SIG-A) 314, a VHT short training field (VHT-STF) 316, a number of VHT long training fields (VHT-LTFs) 318, and a second VHT signal field (VHT-SIG-B) 320 encoded separately from VHT-SIG-A 314. Like the L-STF 308, L-LTF 310, and L-SIG 312, the information in VHT-SIG-A 314 may be duplicated and transmitted in each of the component 20 MHz channels in instances involving the use of a bonded channel.

VHT-STF 316 may be used to improve AGC estimation in a MIMO transmission. VHT-LTFs 318 may be used for MIMO channel estimation and pilot subcarrier tracking. The preamble may include one VHT-LTF 318 for each spatial stream the preamble is transmitted on. VHT-SIG-A 314 may indicate to VHT-compatible APs 102 and STAs 104 that the PPDU is a VHT PPDU. VHT-SIG-A 314 includes signaling information and other information usable by STAs 104 to decode VHT-SIG-B 320. VHT-SIG-A 314 may indicate a bandwidth (BW) of the packet, the presence of space-time block coding (STBC), the number N_{STS} of space-time streams per user, a Group ID indicating the group and user position assigned to a STA, a partial association identifier that may combine the AID and the BSSID, a short guard interval (GI) indication, a single-user/multi-user (SU/MU) coding indicating whether convolutional or LDPC coding is used, a modulation and coding scheme (MCS), an indication of whether a beamforming matrix has been applied to the transmission, a cyclic redundancy check (CRC), and a tail. VHT-SIG-B 320 may be used for MU transmissions and may contain the actual data rate and MPDU or A-MPDU length values for each of the multiple STAs 104, as well as signaling information usable by the STAs 104 to decode data received in the DATA field 322, including, for example, an MCS and beamforming information.

FIG. 3B shows another example PDU 350 usable for wireless communication between an AP and a number of STAs. The PDU 350 may be used for MU-OFDMA or MU-MIMO transmissions. The PDU 350 includes a PHY preamble including a legacy portion 352 and a non-legacy portion 354. The PDU 350 may further include a PHY payload 356 after the preamble, for example, in the form of a PSDU including a DATA field 374. The legacy portion 352 includes L-STF 358, L-LTF 360, and L-SIG 362. The non-legacy portion 354 of the preamble and the DATA field 374 may be formatted as a High Efficiency (HE) WLAN preamble and frame, respectively, in accordance with the IEEE 802.11ax amendment to the IEEE 802.11 wireless communication protocol standard. The non-legacy portion 354 includes a repeated legacy signal field (RL-SIG) 364, a first HE signal field (HE-SIG-A) 366, a second HE signal field (HE-SIG-B) 368 encoded separately from HE-SIG-A 366, an HE short training field (HE-STF) 370, and a number of HE long training fields (HE-LTFs) 372. Like the L-STF 358, L-LTF 360, and L-SIG 362, the information in RL-SIG 364 and HE-SIG-A 366 may be duplicated and transmitted in each of the component 20 MHz channels in instances involving the use of a bonded channel. In contrast, HE-SIG-B 368 may be unique to each 20 MHz channel and may target specific STAs 104.

RL-SIG 364 may indicate to HE-compatible STAs 104 that the PPDU is an HE PPDU. An AP 102 may use HE-SIG-A 366 to identify and inform multiple STAs 104 that the AP has scheduled UL or DL resources for them. HE-SIG-A 366 may be decoded by each HE-compatible STA 104 served by the AP 102. HE-SIG-A 366 includes information usable by each identified STA 104 to decode an associated HE-SIG-B 368. For example, HE-SIG-A 366 may indicate the frame format, including locations and lengths of HE-SIG-Bs 368, available channel bandwidths, modulation and coding schemes (MCSs), among other possibilities. HE-SIG-A 366 also may include HE WLAN signaling information usable by STAs 104 other than the number of identified STAs 104.

HE-SIG-B 368 may carry STA-specific scheduling information such as, for example, per-user MCS values and per-user RU allocation information. In the context of DL MU-OFDMA, such information enables the respective STAs 104 to identify and decode corresponding RUs in the associated data field. Each HE-SIG-B 368 includes a common field and at least one STA-specific (“user-specific”) field. The common field can indicate RU distributions to multiple STAs 104, indicate the RU assignments in the frequency domain, indicate which RUs are allocated for MU-MIMO transmissions and which RUs correspond to MU-OFDMA transmissions, and the number of users in allocations, among other possibilities. The common field may be encoded with common bits, CRC bits, and tail bits. The user-specific fields are assigned to particular STAs 104 and may be used to schedule specific RUs and to indicate the scheduling to other WLAN devices. Each user-specific field may include multiple user block fields (which may be followed by padding). Each user block field may include two user fields that contain information for two respective STAs to decode their respective RU payloads in DATA field 374.

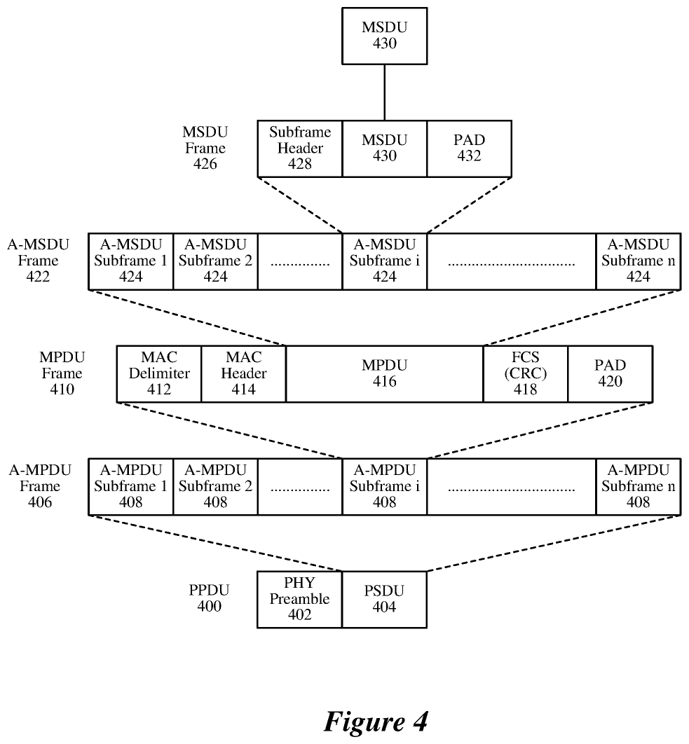

FIG. 4 shows an example PPDU 400 usable for communications between an AP 102 and a number of STAs 104. As described above, each PPDU 400 includes a PHY preamble 402 and a PSDU 404. Each PSDU 404 may represent (or “carry”) one or more MAC protocol data units (MPDUs) 416. For example, each PSDU 404 may carry an aggregated MPDU (A-MPDU) 406 that includes an aggregation of multiple A-MPDU subframes 408. Each A-MPDU subframe 406 may include an MPDU frame 410 that includes a MAC delimiter 412 and a MAC header 414 prior to the accompanying MPDU 416, which comprises the data portion (“payload” or “frame body”) of the MPDU frame 410. Each MPDU frame 410 may also include a frame check sequence (FCS) field 418 for error detection (for example, the FCS field may include a cyclic redundancy check (CRC)) and padding bits 420. The MPDU 416 may carry one or more MAC service data units (MSDUs) 430. For example, the MPDU 416 may carry an aggregated MSDU (A-MSDU) 422 including multiple A-MSDU subframes 424. Each A-MSDU subframe 424 contains a corresponding MSDU 430 preceded by a subframe header 428 and in some cases followed by padding bits 432.

Referring back to the MPDU frame 410, the MAC delimiter 412 may serve as a marker of the start of the associated MPDU 416 and indicate the length of the associated MPDU 416. The MAC header 414 may include a number of fields containing information that defines or indicates characteristics or attributes of data encapsulated within the frame body 416. The MAC header 414 includes a duration field indicating a duration extending from the end of the PPDU until at least the end of an acknowledgment (ACK) or Block ACK (BA) of the PPDU that is to be transmitted by the receiving wireless communication device. The use of the duration field serves to reserve the wireless medium for the indicated duration and enables the receiving device to establish its network allocation vector (NAV). The MAC header 414 also includes a number of fields indicating addresses for the data encapsulated within the frame body 416. For example, the MAC header 414 may include a combination of a source address, a transmitter address, a receiver address, or a destination address. The MAC header 414 may further include a frame control field containing control information. The frame control field may specify a frame type, for example, a data frame, a control frame, or a management frame.

Access to the shared wireless medium is generally governed by a distributed coordination function (DCF). With a DCF, there is generally no centralized master device allocating time and frequency resources of the shared wireless medium. On the contrary, before a wireless communication device, such as an AP 102 or a STA 104, is permitted to transmit data, it must wait for a particular time and then contend for access to the wireless medium. In some implementations, the wireless communication device may be configured to implement the DCF through the use of carrier sense multiple access (CSMA) with collision avoidance (CA) (CSMA/CA) techniques and timing intervals. Before transmitting data, the wireless communication device may perform a clear channel assessment (CCA) and determine that the appropriate wireless channel is idle. The CCA includes both physical (PHY-level) carrier sensing and virtual (MAC-level) carrier sensing. Physical carrier sensing (or packet detection (PD)) is accomplished via a measurement of the received signal strength of a valid frame, which is then compared to a value to determine whether the channel is busy. For example, if the received signal strength of a detected preamble is above the value, the medium is considered busy. Physical carrier sensing also includes energy detection (ED). Energy detection involves measuring the total energy the wireless communication device receives regardless of whether the received signal represents a valid frame. If the total energy detected is above a value, the medium is considered busy. Virtual carrier sensing is accomplished via the use of a network allocation vector (NAV), an indicator of a time when the medium may next become idle. The NAV is reset each time a valid frame is received that is not addressed to the wireless communication device. The NAV effectively serves as a time duration that must elapse before the wireless communication device may contend for access even in the absence of a detected symbol or even if the detected energy is below the value.

As described above, the DCF is implemented through the use of time intervals. These time intervals include the slot time (or “slot interval”) and the inter-frame space (IFS). The slot time is the basic unit of timing and may be determined based on one or more of a transmit-receive turnaround time, a channel sensing time, a propagation delay, and a MAC processing time. Measurements for channel sensing are performed for each slot. All transmissions may begin at slot boundaries. Example varieties of IFS include: the short IFS (SIFS), the distributed IFS (DIFS), the extended IFS (EIFS), or the arbitration IFS (AIFS). For example, the DIFS may be defined as the sum of the SIFS and two times the slot time. The values for the slot time and IFS may be provided by a suitable standard specification, such as one of the IEEE 802.11 family of wireless communication protocol standards (such as that defined by the IEEE 802.11-2016 specification or amendments thereof including, but not limited to, 802.11ah, 802.11ad, 802.11ay, 802.11ax, 802.11az, 802.11ba, and 802.11be).

When the NAV reaches 0, the wireless communication device performs physical carrier sensing. If the channel remains idle for the appropriate IFS (for example, a DIFS), the wireless communication device initiates a backoff timer, which represents a duration of time that the device must sense the medium to be idle before it is permitted to transmit. The backoff timer is decremented by one slot each time the medium is sensed to be idle during a corresponding slot interval. If the channel remains idle until the backoff timer expires, the wireless communication device becomes the holder (or “owner”) of a transmit opportunity (TXOP) and may begin transmitting. The TXOP is the duration of time the wireless communication device can transmit frames over the channel after it has won contention for the wireless medium. If, on the other hand, one or more of the carrier sense mechanisms indicate that the channel is busy, a MAC controller within the wireless communication device will not permit transmission.

Each time the wireless communication device generates a new PPDU for transmission in a new TXOP, it randomly selects a new backoff timer duration. The available distribution of numbers that may be randomly selected for the backoff timer is referred to as the contention window (CW). If, when the backoff timer expires, the wireless communication device transmits the PPDU, but the medium is still busy, there may be a collision. Additionally, if there is otherwise too much energy on the wireless channel resulting in a poor signal-to-noise ratio (SNR), the communication may be corrupted or otherwise not successfully received. In such instances, the wireless communication device may not receive a communication acknowledging the transmitted PDU within a timeout interval. The MAC may then increase the CW exponentially, for example, doubling it, and randomly select a new backoff timer duration from the CW before each attempted retransmission of the PPDU. Before each attempted retransmission, the wireless communication device may wait a duration of DIFS and, if the medium remains idle, proceed to initiate the new backoff timer. There are different CW and TXOP durations for each of the four access categories (ACs): voice (AC_VO), video (AC_VI), background (AC_BK), and best effort (AC_BE). This enables particular types of traffic to be prioritized in the network.

As described above, APs 102 and STAs 104 can support multi-user (MU) communications; that is, concurrent transmissions from one device to each of multiple devices (for example, multiple simultaneous downlink (DL) communications from an AP 102 to corresponding STAs 104), or concurrent transmissions from multiple devices to a single device (for example, multiple simultaneous uplink (UL) transmissions from the corresponding STAs 104 to the AP 102). To support the MU transmissions, the APs 102 and the STAs 104 may utilize multi-user multiple-input, multiple-output (MU-MIMO) and multi-user orthogonal frequency division multiple access (MU-OFDMA) techniques.

In MU-OFDMA schemes, the available frequency spectrum of the wireless channel may be divided into multiple resource units (RUs) each including a number of different frequency subcarriers (“tones”). Different RUs may be allocated or assigned by an AP 102 to different STAs 104 at particular times. The sizes and distributions of the RUs may be referred to as an RU allocation. In some implementations, RUs may be allocated in 2 MHz intervals, and as such, the smallest RU may include 26 tones consisting of 24 data tones and 2 pilot tones. Consequently, in a 20 MHz channel, up to 9 RUs (such as 2 MHz, 26-tone RUs) may be allocated (because some tones are reserved for other purposes). Similarly, in a 160 MHz channel, up to 74 RUs may be allocated. Larger 52-tone, 106-tone, 242-tone, 484-tone, and 996-tone RUs also may be allocated. Adjacent RUs may be separated by a null subcarrier (such as a DC subcarrier), for example, to reduce interference between adjacent RUs, to reduce receiver DC offset, and to avoid transmit center frequency leakage.

For UL MU transmissions, an AP 102 can transmit a trigger frame to initiate and synchronize an UL MU-OFDMA or an UL MU-MIMO transmission from multiple STAs 104 to the AP 102. Such trigger frames may thus enable multiple STAs 104 to send UL traffic to the AP 102 concurrently in time. A trigger frame may address one or more STAs 104 through respective association identifiers (AIDs) and may assign each AID (and thus, each STA 104) one or more RUs that can be used to send UL traffic to the AP 102. The AP also may designate one or more random access (RA) RUs that unscheduled STAs 104 may contend for.

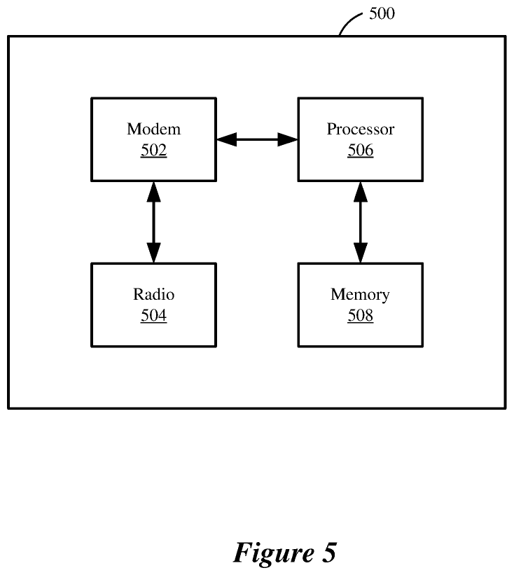

FIG. 5 shows a block diagram of an example wireless communication device 500. In some implementations, the wireless communication device 500 can be an example of a device for use in a STA such as one of the STAs 104 described above with reference to FIG. 1. In some implementations, the wireless communication device 500 can be an example of a device for use in an AP such as the AP 102 described above with reference to FIG. 1. The wireless communication device 500 is capable of transmitting (or outputting for transmission) and receiving wireless communications (for example, in the form of wireless packets). For example, the wireless communication device can be configured to transmit and receive packets in the form of physical layer convergence protocol (PLCP) protocol data units (PPDUs) and medium access control (MAC) protocol data units (MPDUs) conforming to an IEEE 802.11 wireless communication protocol standard, such as that defined by the IEEE 802.11-2016 specification or amendments thereof including, but not limited to, 802.11ah, 802.11ad, 802.11ay, 802.11ax, 802.11az, 802.11ba, and 802.11be.

The wireless communication device 500 can be, or can include, a chip, system on chip (SoC), chipset, package, or device that includes one or more modems 502, for example, a Wi-Fi (IEEE 802.11 compliant) modem. In some implementations, the one or more modems 502 (collectively “the modem 502”) additionally include a WWAN modem (for example, a 3GPP 4G LTE or 5G compliant modem). In some implementations, the wireless communication device 500 also includes one or more radios 504 (collectively “the radio 504”). In some implementations, the wireless communication device 506 further includes one or more processors, processing blocks, or processing elements 506 (collectively “the processor 506”), and one or more memory blocks or elements 508 (collectively “the memory 508”).

The modem 502 can include an intelligent hardware block or device such as, for example, an application-specific integrated circuit (ASIC) among other possibilities. The modem 502 is generally configured to implement a PHY layer. For example, the modem 502 is configured to modulate packets and to output the modulated packets to the radio 504 for transmission over the wireless medium. The modem 502 is similarly configured to obtain modulated packets received by the radio 504 and to demodulate the packets to provide demodulated packets. In addition to a modulator and a demodulator, the modem 502 may further include digital signal processing (DSP) circuitry, automatic gain control (AGC), a coder, a decoder, a multiplexer, and a demultiplexer. For example, while in a transmission mode, data obtained from the processor 506 is provided to a coder, which encodes the data to provide encoded bits. The encoded bits are then mapped to points in a modulation constellation (using a selected MCS) to provide modulated symbols. The modulated symbols may then be mapped to a number N_{SS} of spatial streams or a number N_{STS} of space-time streams. The modulated symbols in the respective spatial or space-time streams may then be multiplexed, transformed via an inverse fast Fourier transform (IFFT) block, and subsequently provided to the DSP circuitry for Tx windowing and filtering. The digital signals may then be provided to a digital-to-analog converter (DAC). The resultant analog signals may then be provided to a frequency upconverter, and ultimately, the radio 504. In implementations involving beamforming, the modulated symbols in the respective spatial streams are precoded via a steering matrix prior to their provision to the IFFT block.

While in a reception mode, digital signals received from the radio 504 are provided to the DSP circuitry, which is configured to acquire a received signal, for example, by detecting the presence of the signal and estimating the initial timing and frequency offsets. The DSP circuitry is further configured to digitally condition the digital signals, for example, using channel (narrowband) filtering, analog impairment conditioning (such as correcting for I/Q imbalance), and applying digital gain to ultimately obtain a narrowband signal. The output of the DSP circuitry may then be fed to the AGC, which is configured to use information extracted from the digital signals, for example, in one or more received training fields, to determine an appropriate gain. The output of the DSP circuitry also is coupled with the demodulator, which is configured to extract modulated symbols from the signal and, for example, compute the logarithm likelihood ratios (LLRs) for each bit position of each subcarrier in each spatial stream. The demodulator is coupled with the decoder, which may be configured to process the LLRs to provide decoded bits. The decoded bits from all of the spatial streams are then fed to the demultiplexer for demultiplexing. The demultiplexed bits may then be descrambled and provided to the MAC layer (the processor 506) for processing, evaluation, or interpretation.

The radio 504 generally includes at least one radio frequency (RF) transmitter (or “transmitter chain”) and at least one RF receiver (or “receiver chain”), which may be combined into one or more transceivers. For example, the RF transmitters and receivers may include various DSP circuitry including at least one power amplifier (PA) and at least one low-noise amplifier (LNA), respectively. The RF transmitters and receivers may, in turn, be coupled to one or more antennas. For example, in some implementations, the wireless communication device 500 can include, or be coupled with, multiple transmit antennas (each with a corresponding transmit chain) and multiple receive antennas (each with a corresponding receive chain). The symbols output from the modem 502 are provided to the radio 504, which then transmits the symbols via the coupled antennas. Similarly, symbols received via the antennas are obtained by the radio 504, which then provides the symbols to the modem 502.

The processor 506 can include an intelligent hardware block or device such as, for example, a processing core, a processing block, a central processing unit (CPU), a microprocessor, a microcontroller, a digital signal processor (DSP), an application-specific integrated circuit (ASIC), a programmable logic device (PLD) such as a field programmable gate array (FPGA), discrete gate or transistor logic, discrete hardware components, or any combination thereof designed to perform the functions described herein. The processor 506 processes information received through the radio 504 and the modem 502, and processes information to be output through the modem 502 and the radio 504 for transmission through the wireless medium. For example, the processor 506 may implement a control plane and MAC layer configured to perform various operations related to the generation and transmission of MPDUs, frames, or packets. The MAC layer is configured to perform or facilitate the coding and decoding of frames, spatial multiplexing, space-time block coding (STBC), beamforming, and OFDMA resource allocation, among other operations or techniques. In some implementations, the processor 506 may generally control the modem 502 to cause the modem to perform various operations described above.

The memory 504 can include tangible storage media such as random-access memory (RAM) or read-only memory (ROM), or combinations thereof. The memory 504 also can store non-transitory processor- or computer-executable software (SW) code containing instructions that, when executed by the processor 506, cause the processor to perform various operations described herein for wireless communication, including the generation, transmission, reception, and interpretation of MPDUs, frames, or packets. For example, various functions of components disclosed herein, or various blocks or steps of a method, operation, process, or algorithm disclosed herein, can be implemented as one or more modules of one or more computer programs.

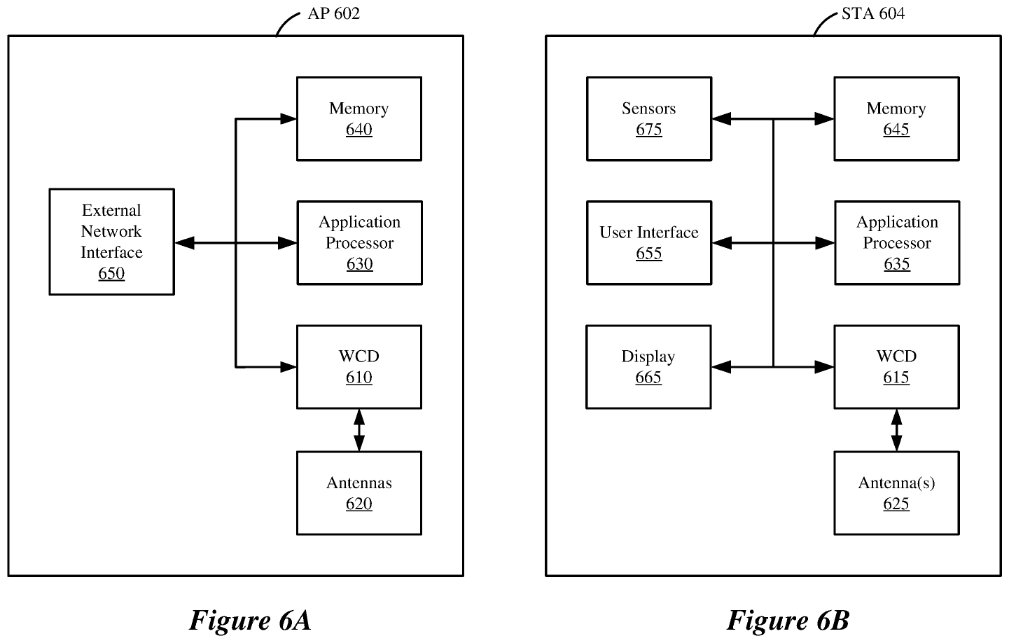

FIG. 6A shows a block diagram of an example AP 602. For example, the AP 602 can be an example implementation of the AP 102 described with reference to FIG. 1. The AP 602 includes a wireless communication device (WCD) 610 (although the AP 602 may itself also be referred to generally as a wireless communication device as used herein). For example, the wireless communication device 610 may be an example implementation of the wireless communication device 500 described with reference to FIG. 5. The AP 602 also includes multiple antennas 620 coupled with the wireless communication device 610 to transmit and receive wireless communications. In some implementations, the AP 602 additionally includes an application processor 630 coupled with the wireless communication device 610, and a memory 640 coupled with the application processor 630. The AP 602 further includes at least one external network interface 650 that enables the AP 602 to communicate with a core network or backhaul network to gain access to external networks including the Internet. For example, the external network interface 650 may include one or both of a wired (for example, Ethernet) network interface and a wireless network interface (such as a WWAN interface). Ones of the aforementioned components can communicate with other ones of the components directly or indirectly, over at least one bus. The AP 602 further includes a housing that encompasses the wireless communication device 610, the application processor 630, the memory 640, and at least portions of the antennas 620 and external network interface 650.

FIG. 6B shows a block diagram of an example STA 604. For example, the STA 604 can be an example implementation of the STA 104 described with reference to FIG. 1. The STA 604 includes a wireless communication device 615 (although the STA 604 may itself also be referred to generally as a wireless communication device as used herein). For example, the wireless communication device 615 may be an example implementation of the wireless communication device 500 described with reference to FIG. 5. The STA 604 also includes one or more antennas 625 coupled with the wireless communication device 615 to transmit and receive wireless communications. The STA 604 additionally includes an application processor 635 coupled with the wireless communication device 615, and a memory 645 coupled with the application processor 635. In some implementations, the STA 604 further includes a user interface (UI) 655 (such as a touchscreen or keypad) and a display 665, which may be integrated with the UI 655 to form a touchscreen display. In some implementations, the STA 604 may further include one or more sensors 675 such as, for example, one or more inertial sensors, accelerometers, temperature sensors, pressure sensors, or altitude sensors. Ones of the aforementioned components can communicate with other ones of the components directly or indirectly, over at least one bus. The STA 604 further includes a housing that encompasses the wireless communication device 615, the application processor 635, the memory 645, and at least portions of the antennas 625, UI 655, and display 665.

As mentioned above, wireless communication devices may contend with each other for access to a shared wireless medium. The IEEE 802.11 standards define a distributed coordination function (DCF) in which wireless communication devices use carrier sensing techniques to determine that the wireless medium has been idle for a period of time before attempting to transmit data on the wireless medium. Many wireless communication devices employ an Enhanced Distributed Channel Access (EDCA) mechanism for medium access contention operations. The EDCA mechanism is an example of a listen-before-talk (LBT) channel access mechanism, and may prevent multiple devices from accessing the wireless medium at the same time by arbitrating access to the wireless medium using randomly selected numbers representing periods of time during which the wireless medium is to remain idle before a given wireless communication device may transmit on the wireless medium.

As the number of wireless communication devices associated with an AP increases, the likelihood of collisions on the wireless medium also increases, which may decrease throughput of the wireless network. The ability to provide a certain quality-of-service (QoS) in a wireless network may depend on the throughput of the wireless network. Decreases in either UL throughput or DL throughput of the wireless network may reduce an AP's ability to guarantee certain levels of QoS for time-critical traffic flows (such as voice and video calls). Further, the presence of legacy devices that do not support multiple-access communication schemes (such as Orthogonal Frequency-Division Multiple Access (OFDMA) modulation schemes) in a wireless network may decrease DL throughput to a greater extent than UL throughput, and may therefore exacerbate imbalances between UL and DL throughput of the wireless network. Imbalances between UL and DL throughput may limit or restrict the number of bi-directional symmetric traffic flows (such as voice and video calls) that can be supported by a wireless network for a given number of associated devices.

Implementations of the subject matter described in this disclosure may be used to maintain a balance between UL and DL throughput in a contention-based wireless network in response to one or more of an increase in UL traffic relative to DL traffic in the wireless network, an increase in the level of contention in the wireless network, an increase in the number of wireless communication devices actively associated with an AP, or an increase in the number of collisions in the wireless network. In some implementations, a wireless communication device contending for medium access to transmit UL data on a shared wireless medium may detect a presence of downlink (DL) data and adjust its backoff counter based on whether the wireless communication device is an intended recipient of the DL data. The wireless communication device may not adjust the backoff counter when it is not the intended recipient of the DL data, and may adjust the backoff counter when it is one of the intended recipients of the DL data. In some implementations, not adjusting the backoff counter may include stopping the countdown of the backoff counter in response to detecting the presence of the DL data, and continuing, during a next medium access contention operation, the countdown of the backoff counter from where it was stopped. In some implementations, adjusting the backoff counter may include resetting the backoff counter to an initial value in response to receiving the DL data.

By resetting the backoff counter to an initial value in response to receiving DL data, rather than pausing the backoff counter, a wireless communication device may have a longer backoff period during one or more subsequent medium access contention operations on a wireless medium, thereby decreasing a likelihood of the wireless communication device obtaining a transmit opportunity (TXOP) to transmit UL data on the wireless medium during the one or more subsequent medium access contention operations. Reducing or delaying UL transmissions from wireless communication devices that also received DL data may decrease the amount of UL traffic relative to the amount of DL traffic, thereby increasing symmetry between UL and DL throughput on the wireless medium. In this manner, implementations of the subject matter described in this disclosure may increase the number of traffic flows having substantially symmetrical UL and DL traffic (such as voice and video calls) that can be supported by a wireless network that includes a given number of associated wireless communication devices (such as STAs).

In other implementations, an AP may indicate a contention window size to be used by one or more associated wireless communication devices for medium access contention operations. The indicated contention window size may be based on one or more of a number of collisions on the shared wireless medium, an amount of traffic on the shared wireless medium, an increase in the number of wireless communication devices actively associated with an AP, or a level of contention on the shared wireless medium. For example, in response to an increase in the number of active wireless communication devices associated with an AP, the AP may indicate a larger contention window size from which wireless communication devices contending for medium access are to randomly select their backoff numbers.

The ability to indicate or modify a contention window size to be used by one or more wireless communication devices contending for medium access may allow the AP to at least partially determine or adjust the backoff periods during which the contending devices must wait before transmitting on the wireless medium. In some implementations, the AP may cause or instruct the wireless communication devices to increase their backoff periods (or at least a maximum duration of their backoff periods) when the imbalance between DL and UL throughput is greater than a value. In this manner, when the DL throughput is at a relatively low level (such as compared with the UL throughput), the AP may delay or decrease the likelihood of UL transmissions from wireless communication devices that received DL data.

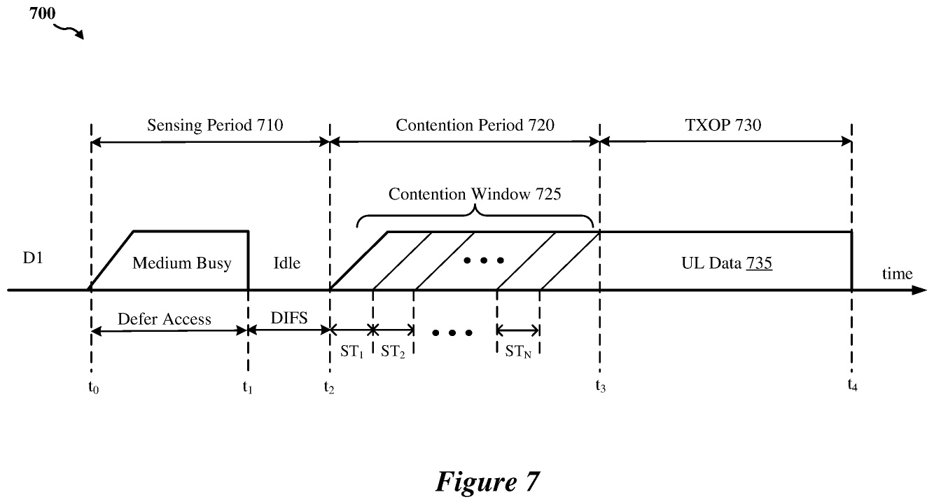

FIG. 7 shows a timing diagram 700 illustrating the transmissions of communications according to some implementations. The communications may relate to medium access contention operations. In some implementations, the wireless communication device D1 described with reference to FIG. 7 may operate as or within a STA, such as one of the STAs 104 and 604 described above with reference to FIGS. 1 and 6B, respectively. In some other implementations, the wireless communication device D1 may operate as or within an AP, such as one of the APs 102 and 602 described above with reference to FIGS. 1 and 6A, respectively.

In some implementations, the device D1 and one or more other wireless devices (not shown for simplicity) may contend for medium access using an EDCA mechanism, which may be implemented through the use of CSMA/CA and timing intervals such as SIFS, DIFS, EIFS, and AIFS. For example, the device D1 may randomly select or generate a backoff number from a range of numbers defined by a contention window (CW), and may set its backoff counter to an initial value based on the randomly selected backoff number. The size of the contention window may be initially set to a minimum value (CWₘᵢₙ), for example, such that the backoff number is randomly selected from a range of numbers between 0 and CWₘᵢₙ.

The device D1 may sense the wireless medium, and decrement its backoff counter by one slot each time the wireless medium is continuously idle for an appropriate IFS period (such as a DIFS period). When the backoff counter reaches zero, the device D1 may become the owner of a TXOP and transmit UL data on the wireless medium for a duration of the TXOP. If there is a collision on the wireless medium, the device D1 may use an exponential backoff procedure in which the CW size is doubled for each subsequent medium access contention operation. When the contention window reaches a maximum value (CWₘₐₓ), the contention window size remains at CWₘₐₓ until one of the contending devices wins access to the shared wireless medium. The one or more other wireless devices contending for medium access follow a similar procedure and decrement their backoff counters from randomly selected backoff numbers between 0 and CWₘᵢₙ each time the wireless medium is sensed to be idle for the appropriate IFS period.

With reference to FIG. 7, at time t₀, a sensing period 710 begins during which the device D1 senses or determines whether the wireless medium is idle or busy. The device D1 senses that the wireless medium is busy between times t₀ and t₁, and may defer medium access contention operations. The wireless medium becomes free at time t₁, and remains idle until at least time t₂. The device D1 senses that the wireless medium has been continuously idle for a DIFS period between times t₁ and t₂, decrements its backoff counter by one slot, and enters a contention period 720 at time t₂.

During the contention period 720, the device D1 may contend with the one or more other wireless devices for medium access. The device D1 and each of the one or more other wireless devices waits for a period of time determined by their respective randomly selected backoff numbers before attempting to transmit on the wireless medium. Each of the randomly selected backoff numbers may correspond to one of a number of slot times ST₁-ST_{N} within a contention window 725, and may indicate a backoff period for a corresponding one of the contending devices. The contending device that selects the lowest backoff number has the shortest backoff period, and “wins” the medium access contention operation. For the example of FIG. 7, the device D1 selected the lowest backoff number (which corresponds to the earliest one of the slot times ST₁-ST_{N}), and becomes the owner of a TXOP 730 on the wireless medium. The device D1 may transmit UL data 735 on the wireless medium for a duration of the TXOP 730 between times t₃ and t₄.

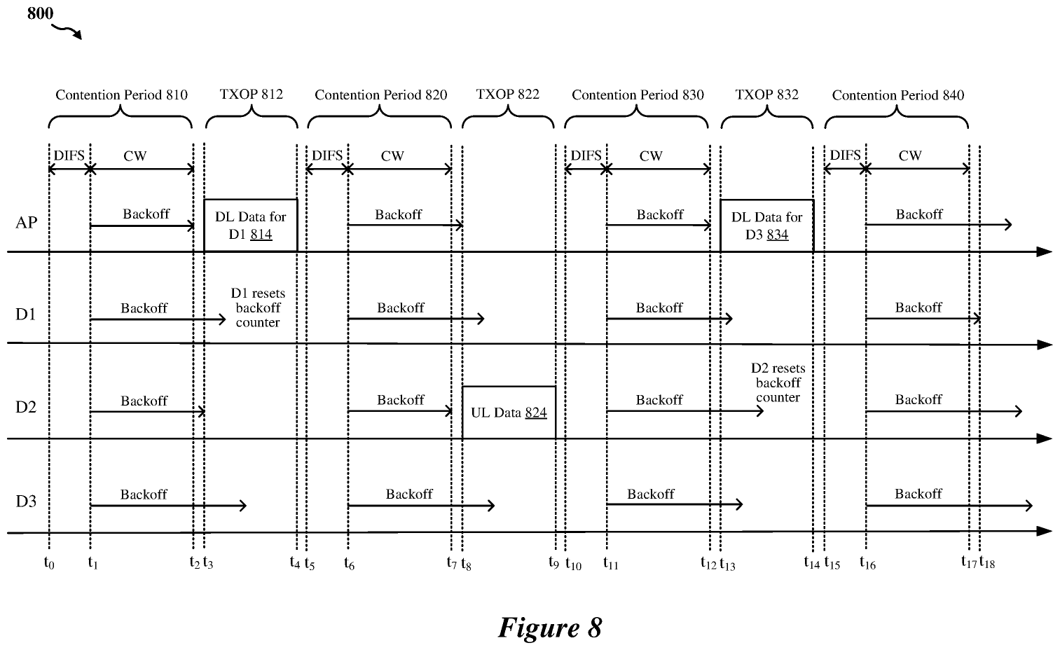

FIG. 8 shows a timing diagram 800 illustrating the transmissions of communications according to some implementations. The communications may relate to medium access contention operations performed by an AP and three wireless communication devices D1-D3 associated with the AP. In some implementations, the devices D1-D3 may be examples of the STAs 104 and 604 described above with reference to FIGS. 1 and 6B, respectively, and the AP may be an example of the AP 102 and 602 described above with reference to FIGS. 1 and 6A, respectively. Although three contending devices D1-D3 are shown in the example of FIG. 8, the medium access contention operations described herein may be performed by any suitable number of wireless communication devices.

The AP and devices D1-D3 each select a random backoff number between 0 and CWₘᵢₙ, and initialize their backoff counter to the selected backoff number. For the example of FIG. 8, the AP selects a random backoff number of 1, the device D1 selects a random backoff number of 4, the device D2 selects a random backoff number of 2, and the device D3 selects a random backoff number of 6.

At time t₀, a first contention period 810 begins. After sensing that the wireless medium has been continuously idle for a DIFS period between times t₀ and t₁, each of the AP and the devices D1-D3 initiates a countdown of its respective backoff counter, for example, by decrementing its backoff counter by one slot, and contends with the other ones of the devices for medium access during a first contention window (CW) between times t₁ and t₂. The AP's backoff counter is decremented from 1 to 0, device D1's backoff counter is decremented from 4 to 3, device D2's backoff counter is decremented from 2 to 1, and device D3's backoff counter is decremented from 6 to 5.

The AP selected the lowest backoff number, and as such, its backoff counter reaches zero before the backoff counters of devices D1-D3. As a result, the AP wins the medium access contention operation, and becomes the owner of a first TXOP 812 on the wireless medium. The AP transmits DL data 814 to the device D1 on the wireless medium during the first TXOP 812 between times t₃ and t₄. In some implementations, the DL data 814 may be a single-user (SU) packet, a multi-user (MU) packet, or an aggregated packet. In various implementations, the DL data 814 may be transmitted using any suitable format. After the DL transmission, the AP may select a new random backoff number between 0 and CWₘᵢₙ. For the example of FIG. 8, the AP selects a new backoff number of 2, and sets its backoff counter to an initial value of 2 accordingly.

During the first TXOP 812, each of the devices D1-D3 detects a presence of the DL data 814 on the wireless medium, and determines whether it is an intended recipient of the DL data 814. The devices D2 and D3 are not intended recipients of the DL data 814, and may stop the countdown of their backoff counters based on the detection of the DL data 814. The device D1 determines that it is the intended recipient of the DL data 814, and adjusts its backoff counter based on receiving the DL data 814. In some implementations, the device D1 may adjust its backoff counter by resetting the backoff counter to its initial value (such as the backoff number randomly selected by the device D1). For the example of FIG. 8, the device D1 resets its backoff counter to 4.

Resetting device D1's backoff counter to its initial value of 4, rather than stopping the countdown of the backoff counter at 3, based on the reception of the DL data 814 may delay or reduce a likelihood of UL transmissions from the device D1, which may not only decrease UL traffic on the wireless medium but also increase the likelihood of the AP winning contention operations and transmitting DL data on the wireless medium.

After a SIFS period between times t₄ and t₅, a second contention period 820 begins. Sensing that the wireless medium has been continuously idle for a DIFS period between times t₅ and t₆, the AP and devices D1-D3 decrement their respective backoff counters by one slot, and contend with each other for medium access during a second CW between times t₆ and t₇. The AP's backoff counter is decremented from 2 to 1, device D1's backoff counter is decremented from 4 to 3, device D2's backoff counter is decremented from 1 to 0, and device D3's backoff counter is decremented from 5 to 4.

Device D2's backoff counter reaches zero before the backoff counters of the AP, device D1, and device D3. Thus, device D2 wins the medium access contention operation, and becomes the owner of a second TXOP 822 on the wireless medium. The device D2 transmits UL data 824 during the second TXOP 822 between times t₈ and t₉, and randomly selects a new backoff number between 0 and CWₘᵢₙ. For the example of FIG. 8, the device D2 selects a new backoff number of 6, and sets its backoff counter to the new backoff number of 6.

After a SIFS period between times t₉ and t₁₀, a third contention period 830 begins. Sensing that the wireless medium has been continuously idle for a DIFS period between times t₁₀ and t₁₁, the AP and devices D1-D3 decrement their respective backoff counters by one slot, and contend with each other for medium access during a third CW between times t₁₁ and t₁₂. The AP's backoff counter is decremented from 1 to 0, device D1's backoff counter is decremented from 3 to 2, device D2's backoff counter is decremented from 6 to 5, and device D3's backoff counter is decremented from 4 to 3.

In this example, the AP selected the lowest backoff number, and its backoff counter reaches zero before the backoff counters of devices D1-D3. Thus, the AP again wins the medium access contention operation, and becomes the owner of a third TXOP 832 on the wireless medium. The AP transmits DL data 834 to the device D3 during the third TXOP 832 between times t₁₃ and t₁₄. In some implementations, the DL data 834 may be an SU packet, an MU packet, or an aggregated packet. After the DL transmission, the AP randomly selects a new backoff number between 0 and CWₘᵢₙ. For the example of FIG. 8, the AP selects a new backoff number of 5, and sets its backoff counter to the new backoff number of 5.

During the third TXOP 832, each of the devices D1-D3 detects a presence of the DL data 834 on the wireless medium, and determines whether it is an intended recipient of the DL data 834. The devices D1 and D2 are not intended recipients of the DL data 834, and may stop the countdown of their backoff counters based on the detection of the DL data 834. The device D3 determines that it is the intended recipient of the DL data 834, and adjusts its backoff counter based on receiving the DL data 834. As described above, in some implementations, the device D3 may adjust its backoff counter by resetting the backoff counter to its initial value of 6. Resetting device D3's backoff counter to its initial value of 6, rather than stopping the countdown of the backoff counter at 3, based on the reception of the DL data 834 may delay or reduce a likelihood of UL transmissions from the device D3, which may not only decrease UL traffic on the wireless medium but also increase the likelihood of the AP winning contention operations and transmitting DL data on the wireless medium.

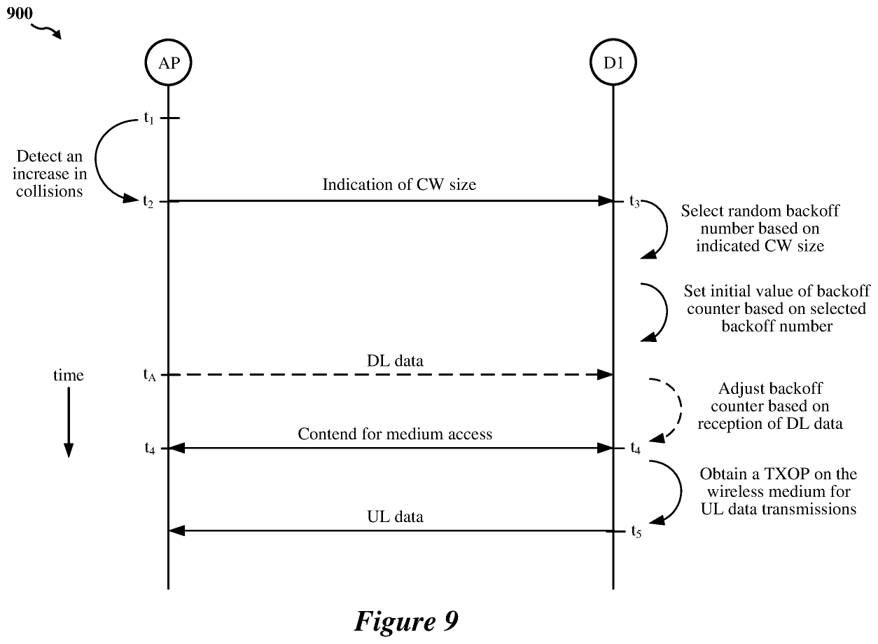

FIG. 9 shows a sequence diagram 900 illustrating the transmissions of communications according to some implementations. The communications may relate to medium access contention operations performed by an AP and a wireless communication device D1 associated with the AP. In some implementations, the device D1 may be an example of the STAs 104 and 604 described above with reference to FIGS. 1 and 6B, respectively, and the AP may be an example of the AP 102 and 602 described above with reference to FIGS. 1 and 6A, respectively. Although only one wireless communication device D1 is shown in the example of FIG. 9, the medium access contention operations described herein may be performed by any suitable number of wireless communication devices.

At time t₁, the AP may detect a decrease in DL throughput of an associated wireless network. The decrease in DL throughput may be caused by any number of conditions or factors including (but not limited to) an increase in the number of collisions on the wireless medium, an increase in the number of active wireless communication devices associated with the AP, an increase in the amount of traffic on the wireless medium, or an increase in the level of contention on the wireless medium. In some implementations, the AP may select (or adjust) the size of the contention window used by the device D1 for randomly selecting backoff numbers based on the detected decrease in DL throughput (such as by increasing the contention window size).

At time t₂, the AP may transmit an indication of the selected contention window size to be used by the device D1. In some implementations, the indication may be included within an information element (IE) of one or more beacon frames transmitted by the AP. In some other implementations, the indication may be included within another suitable frame or packet transmitted by the AP.

The device D1 receives the indication at time t₃, and selects a random backoff number from a range of numbers defined by the contention window size indicated by the AP. The device D1 may set an initial value of its backoff counter to the randomly selected backoff number, and may begin sensing the wireless medium to determine whether the wireless medium is busy or idle.

If the AP transmits DL data to the device D1 (such as at time t_{A}), the device D1 may reset its backoff counter to its initial state, as described with reference to FIG. 8. If the AP transmits DL data that is not addressed to the device D1, the device D1 may pause or stop the countdown of its backoff counter.

At time t₄, the device D1 contends with the AP (and other nearby wireless communication devices, not shown for simplicity) for medium access based on a backoff number randomly selected from the contention window size indicated by the AP. At time t₅, the device D1 becomes the owner of a TXOP on the wireless medium, and transmits UL data to the AP.

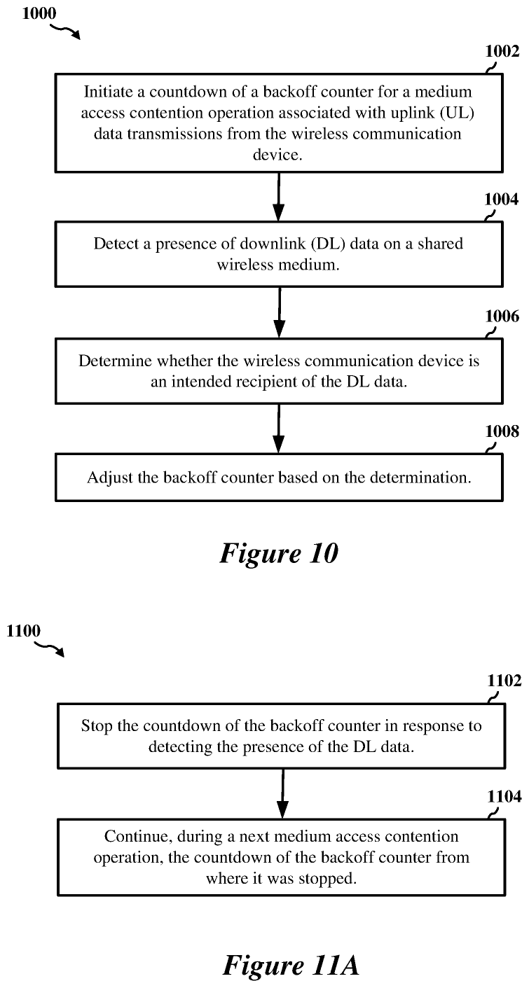

FIG. 10 shows a flowchart illustrating an example process 1000 for wireless communication according to some implementations. The process 1000 may be performed by a wireless communication device such as the wireless communication device 500 described above with reference to FIG. 5. In some implementations, the process 1000 may be performed by a wireless communication device operating as or within a STA, such as one of the STAs 104 and 604 described above with reference to FIGS. 1 and 6B, respectively, or as one of the wireless communication devices D1-D3 described above with reference to FIGS. 7, 8, and 9.

In some implementations, in block 1002, the wireless communication device initiates a countdown of a backoff counter associated with a medium access contention operation for transmitting uplink (UL) data on a shared wireless medium. In block 1004, the wireless communication device detects a presence of downlink (DL) data on the shared wireless medium. In block 1006, the wireless communication device determines whether the wireless communication device is an intended recipient of the DL data. In block 1008, the wireless communication device adjusts the backoff counter based on the determination.

In some implementations, adjusting, in block 1008, the backoff counter based on the determination in block 1006 includes resetting the backoff counter to an initial value in response to determining, in block 1006, that the wireless communication device is an intended recipient of the DL data. In some implementations, adjusting, in block 1008, the backoff counter based on the determination in block 1006 includes not adjusting the backoff counter in response to determining, in block 1006, that the wireless communication device is not an intended recipient of the DL data.

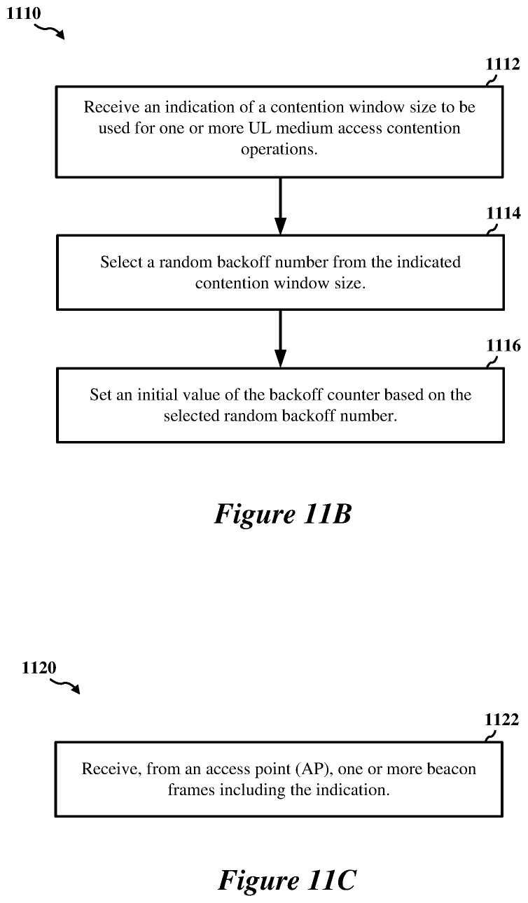

FIG. 11A shows a flowchart illustrating an example process 1100 for wireless communication according to some implementations. The process 1100 may be performed by a wireless communication device such as the wireless communication device 500 described above with reference to FIG. 5. In some implementations, the process 1100 may be performed by a wireless communication device operating as or within a STA, such as one of the STAs 104 and 604 described above with reference to FIGS. 1 and 6B, respectively, or as one of the wireless communication devices D1-D3 described above with reference to FIGS. 7, 8, and 9. For example, the process 1100 may be one implementation of adjusting, in block 1008 of the process 1000, the backoff counter in response to determining, in block 1006 of the process 1000, that the wireless communication device is not an intended recipient of the DL data.

In some implementations, in block 1102, the wireless communication device stops the countdown of the backoff counter in response to detecting the presence of the DL data (for example, as detected in block 1004 of the process 1000). In block 1104, the wireless communication device continues, during a next medium access contention operation, the countdown of the backoff counter from where it was stopped.

FIG. 11B shows a flowchart illustrating an example process 1110 for wireless communication according to some implementations. The process 1110 may be performed by a wireless communication device such as the wireless communication device 500 described above with reference to FIG. 5. In some implementations, the process 1110 may be performed by a wireless communication device operating as or within a STA, such as one of the STAs 104 and 604 described above with reference to FIGS. 1 and 6B, respectively, or as one of the wireless communication devices D1-D3 described above with reference to FIGS. 7, 8, and 9. For example, the process 1110 may be one implementation of initiating the countdown of the backoff counter in block 1002 of FIG. 10.

In some implementations, in block 1112, the wireless communication device receives an indication of a contention window size to be used for one or more UL medium access contention operations. In block 1114, the wireless communication device selects a random backoff number from the indicated contention window size. In block 1116, the wireless communication device sets an initial value of the backoff counter based on the selected random backoff number.

FIG. 11C shows a flowchart illustrating an example process 1120 for wireless communication according to some implementations. The process 1120 may be performed by a wireless communication device such as the wireless communication device 500 described above with reference to FIG. 5. In some implementations, the process 1120 may be performed by a wireless communication device operating as or within a STA, such as one of the STAs 104 and 604 described above with reference to FIGS. 1 and 6B, respectively, or as one of the wireless communication devices D1-D3 described above with reference to FIGS. 7, 8, and 9. For example, the process 1120 may be performed prior to initiating the countdown of the backoff counter in block 1002 of FIG. 10.

In some implementations, in block 1122, the wireless communication device receives, from an access point (AP), one or more beacon frames including the indication. The indication may be included within or appended to any suitable portion of the beacon frames. In some implementations, the indication of the contention window size may be included within an information element (IE) of one or more beacon frames.

In some implementations, the indicated contention window size may be based on the number of devices associated with the AP. In some other implementations, the indicated contention window size may be based on one or more of a number of collisions on the shared wireless medium, an amount of traffic on the shared wireless medium, or a level of contention on the shared wireless medium. In addition, or in the alternative, the indicated contention window size may be based on a relationship between UL and DL throughput on the shared wireless medium. For example, when the UL throughput decreases relative to the DL throughput (such as because of an increase in the number of wireless communication devices associated with the AP), the contention window size may be increased to reduce the likelihood of UL transmissions from the associated wireless communication devices during one or more subsequent TXOPs, which as described with reference to FIG. 9 may reduce imbalances between UL and DL throughput.

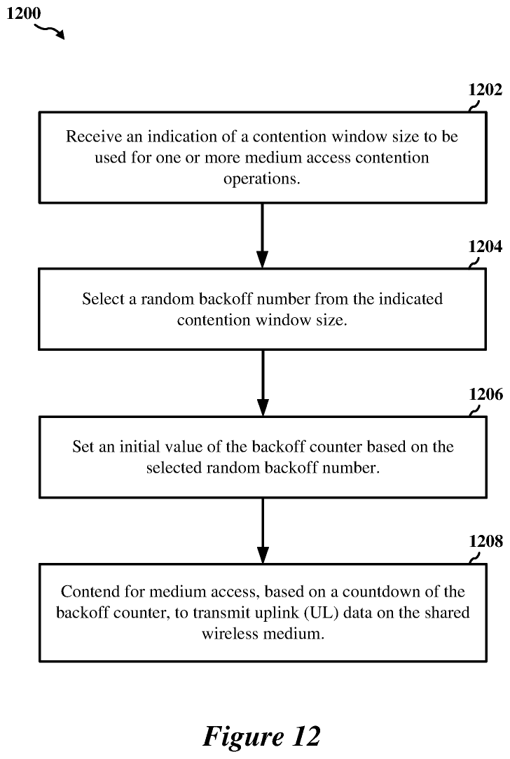

FIG. 12 shows a flowchart illustrating an example process 1200 for wireless communication according to some implementations. The process 1200 may be performed by a wireless communication device such as the wireless communication device 500 described above with reference to FIG. 5. In some implementations, the process 1200 may be performed by a wireless communication device operating as or within a STA, such as one of the STAs 104 and 604 described above with reference to FIGS. 1 and 6B, respectively, or as one of the wireless communication devices D1-D3 described above with reference to FIGS. 7, 8, and 9.

In some implementations, in block 1202, the wireless communication device receives an indication of a contention window size to be used for one or more medium access contention operations. In block 1204, the wireless communication device selects a random backoff number from the indicated contention window size. In block 1206, the wireless communication device sets an initial value of the backoff counter based on the selected random backoff number. In block 1208, the wireless communication device contends for medium access, based on a countdown of the backoff counter, to transmit uplink (UL) data on the shared wireless medium.

In some implementations, the indicated contention window size in block 1202 may be based on one or more of a number of collisions on the shared wireless medium, an amount of traffic on the shared wireless medium, or a level of contention on the shared wireless medium. In addition, or in the alternative, the indicated contention window size may be based on a relationship between DL throughput and UL throughput on the shared wireless medium. For example, when the UL throughput decreases relative to the DL throughput (such as because of an increase in the number of wireless communication devices associated with the AP), the contention window size may be increased to reduce the likelihood of UL transmissions from the associated wireless communication devices during one or more subsequent TXOPs, which as described with reference to FIG. 9 may reduce imbalances between UL and DL throughput. In various implementations, in block 1202, the wireless communication device receives, from an access point (AP), one or more beacon frames including the indication.

In some implementations, contending for medium access in block 1208 may be implemented using the example processes 1000 and 1100 of FIG. 10 and FIG. 11A, respectively.

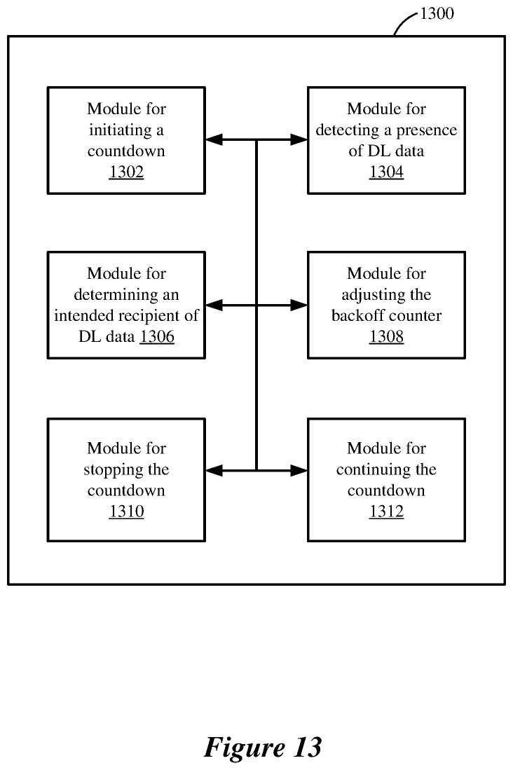

FIG. 13 shows a block diagram of an example wireless communication device 1300 according to some implementations. In some implementations, the wireless communication device 1300 is configured to perform one or more of the processes 1000, 1100, 1110, and 1120 described above with reference to FIGS. 10, 11A, 11B, and 11C, respectively. The wireless communication device 1300 may be an example implementation of the wireless communication device 500 described above with reference to FIG. 5. For example, the wireless communication device 1300 can be a chip, SoC, chipset, package, or device that includes at least one processor and at least one modem (for example, a Wi-Fi (IEEE 802.11) modem or a cellular modem). In some implementations, the wireless communication device 1300 can be a device for use in a STA, such as one of the STAs 104 and 604 described above with reference to FIGS. 1 and 6B, respectively. In some other implementations, the wireless communication device 1300 can be a STA that includes such a chip, SoC, chipset, package, or device as well as at least one transmitter, at least one receiver, and at least one antenna.

The wireless communication device 1300 includes a module for initiating a countdown 1302, a module for detecting a presence of DL data 1304, a module for determining an intended recipient of DL data 1306, a module for adjusting the backoff counter 1308, a module for stopping the countdown 1310, and a module for continuing the countdown 1312. Portions of one or more of the modules 1302, 1304, 1306, 1308, 1310, and 1312 may be implemented at least in part in hardware or firmware. For example, the module for detecting a presence of DL data 1304 and the module for determining an intended recipient of DL data 1306 may be implemented at least in part by a modem (such as the modem 502). In some implementations, at least some of the modules 1304, 1306, 1308, 1310, and 1312 are implemented at least in part as software stored in a memory (such as the memory 508). For example, portions of one or more of the modules 1304, 1306, 1308, 1310, and 1312 can be implemented as non-transitory instructions (or “code”) executable by a processor (such as the processor 506) to perform the functions or operations of the respective module.

The wireless communication device 1300 may contend for access to a shared wireless medium. The module for initiating a countdown 1302 is configured to initiate a countdown of a backoff counter associated with a medium access contention operation for transmitting uplink (UL) data on a shared wireless medium. The module for detecting a presence of DL data 1304 is configured to detect a presence of downlink (DL) data on the shared wireless medium. The module for determining an intended recipient of DL data 1306 is configured to determine whether the wireless communication device 1300 is an intended recipient of the DL data. The module for adjusting the backoff counter 1308 is configured to reset the backoff counter to an initial value in response to determining that the wireless communication device 1300 is an intended recipient of the DL data, and to not adjust the backoff counter in response to determining that the wireless communication device 1300 is not an intended recipient of the DL data. The module for stopping the countdown 1310 is configured to stop the countdown of the backoff counter in response to detecting the presence of the DL data. The module for continuing the countdown 1312 is configured to continue, during a next medium access contention operation, the countdown of the backoff counter from where it was stopped.

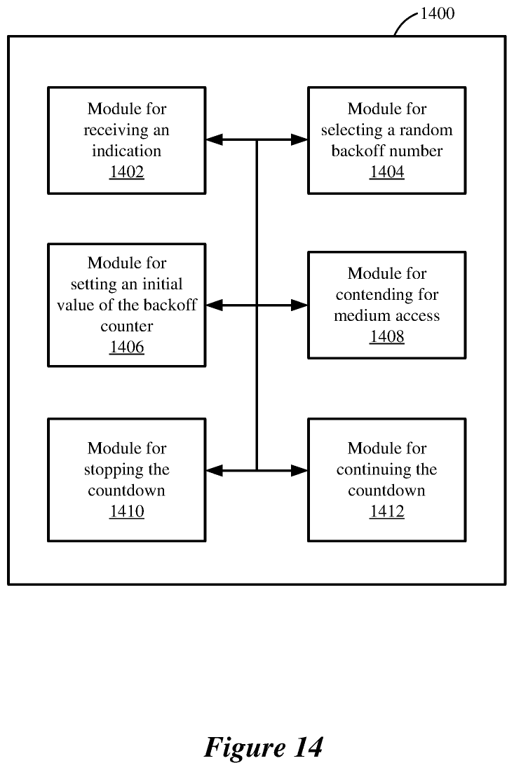

FIG. 14 shows a block diagram of an example wireless communication device 1400 according to other implementations. In some implementations, the wireless communication device 1400 is configured to perform one or more of the processes 1000, 1100, and 1200 described above with reference to FIGS. 10, 11A, and 12, respectively. The wireless communication device 1400 may be an example implementation of the wireless communication device 500 described above with reference to FIG. 5. For example, the wireless communication device 1400 can be a chip, SoC, chipset, package, or device that includes at least one processor and at least one modem (for example, a Wi-Fi (IEEE 802.11) modem or a cellular modem). In some implementations, the wireless communication device 1400 can be a device for use in a STA, such as one of the STAs 104 and 604 described above with reference to FIGS. 1 and 6B, respectively. In some other implementations, the wireless communication device 1400 can be a STA that includes such a chip, SoC, chipset, package, or device as well as at least one transmitter, at least one receiver, and at least one antenna.

The wireless communication device 1400 includes a module for receiving an indication 1402, a module for selecting a random backoff number 1404, a module for setting an initial value of the backoff counter 1406, a module for contending for medium access 1408, a module for stopping the countdown 1410, and a module for continuing the countdown 1412. Portions of one or more of the modules 1402, 1404, 1406, 1408, 1410, and 1412 may be implemented at least in part in hardware or firmware. For example, the module for receiving an indication 1402 and the module for contending for medium access 1408 may be implemented at least in part by a modem (such as the modem 502). In some implementations, at least some of the modules 1404, 1406, 1408, 1410, and 1412 are implemented at least in part as software stored in a memory (such as the memory 508). For example, portions of one or more of the modules 1404, 1406, 1408, 1410, and 1412 can be implemented as non-transitory instructions (or “code”) executable by a processor (such as the processor 506) to perform the functions or operations of the respective module.

The wireless communication device 1400 may contend for access to a shared wireless medium. The module for receiving an indication 1402 is configured to receive indications of a contention window size that may be included in one or more beacon frames transmitted by an AP. The module for selecting a random backoff number 1404 is configured to randomly select a backoff number from a range of numbers defined by a contention window. The module for setting an initial value of the backoff counter 1406 is configured to initialize a value of the backoff counter based on the randomly selected backoff number. The module for contending for medium access 1408 is configured to perform medium access contention operations for transmitting UL data on a shared wireless medium. The module for stopping the countdown 1410 is configured to stop the countdown of the backoff counter in response to detecting the presence of DL data on the wireless medium. The module for continuing the countdown 1412 is configured to continue, during a next medium access contention operation, the countdown of the backoff counter from where it was stopped.

As used herein, a phrase referring to “at least one of” or “one or more of” a list of items refers to any combination of those items, including single members. For example, “at least one of: a, b, or c” is intended to cover the possibilities of: a only, b only, c only, a combination of a and b, a combination of a and c, a combination of b and c, and a combination of a and b and c.

The various illustrative components, logic, logical blocks, modules, circuits, operations and algorithm processes described in connection with the implementations disclosed herein may be implemented as electronic hardware, firmware, software, or combinations of hardware, firmware or software, including the structures disclosed in this specification and the structural equivalents thereof. The interchangeability of hardware, firmware and software has been described generally, in terms of functionality, and illustrated in the various illustrative components, blocks, modules, circuits and processes described above. Whether such functionality is implemented in hardware, firmware or software depends upon the particular application and design constraints imposed on the overall system.

Various modifications to the implementations described in this disclosure may be readily apparent to persons having ordinary skill in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein.

Additionally, various features that are described in this specification in the context of separate implementations also can be implemented in combination in a single implementation. Conversely, various features that are described in the context of a single implementation also can be implemented in multiple implementations separately or in any suitable subcombination. As such, although features may be described above as acting in particular combinations, and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flowchart or flow diagram. However, other operations that are not depicted can be incorporated in the example processes that are schematically illustrated. For example, one or more additional operations can be performed before, after, simultaneously, or between any of the illustrated operations. In some circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

What is claimed is:

1. A method for wireless communication performed by a wireless communication device, comprising:
initiating a countdown of a backoff counter associated with a medium access contention operation for transmitting uplink (UL) data on a shared wireless medium;
detecting a presence of downlink (DL) data on the shared wireless medium;
determining whether the wireless communication device is an intended recipient of the DL data; and
adjusting the backoff counter based on the determination.

2. The method of claim 1, wherein adjusting the backoff counter based on the determination comprises resetting the backoff counter to an initial value in response to determining that the wireless communication device is an intended recipient of the DL data.

3. The method of claim 1, wherein adjusting the backoff counter based on the determination comprises not adjusting the backoff counter in response to determining that the wireless communication device is not an intended recipient of the DL data.

4. The method of claim 3, further comprising:
stopping the countdown of the backoff counter in response to detecting the presence of the DL data; and
continuing, during a next medium access contention operation, the countdown of the backoff counter from where it was stopped.

5. The method of claim 1, wherein the DL data comprises a single-user (SU) packet, a multi-user (MU) packet, or an aggregated packet.

6. The method of claim 1, wherein initiating the countdown of the backoff counter comprises:
receiving an indication of a contention window size to be used for one or more UL medium access contention operations;
selecting a random backoff number from the indicated contention window size; and
setting an initial value of the backoff counter based on the selected random backoff number.

7. The method of claim 6, further comprising receiving, from an access point (AP), one or more beacon frames including the indicated contention window size.

8. The method of claim 7, wherein the indicated contention window size is proportional to a number of devices associated with the AP.

9. The method of claim 6, wherein the indicated contention window size is based on one or more of a number of collisions on the shared wireless medium, an amount of traffic on the shared wireless medium, or a level of contention on the shared wireless medium.

10. The method of claim 6, wherein the indicated contention window size is based on a relationship between DL throughput and UL throughput on the shared wireless medium.

11. A wireless communication device comprising:
at least one modem;
at least one processor communicatively coupled with the at least one modem; and
at least one memory communicatively coupled with the at least one processor and storing processor-readable code that, when executed by the at least one processor in conjunction with the at least one modem, is configured to perform operations comprising:
initiating a countdown of a backoff counter associated with a medium access contention operation for transmitting uplink (UL) data on a shared wireless medium;
detecting a presence of downlink (DL) data on the shared wireless medium;
determining whether the wireless communication device is an intended recipient of the DL data; and
adjusting the backoff counter based on the determination.

12. The wireless communication device of claim 11, wherein adjusting the backoff counter based on the determination comprises resetting the backoff counter to an initial value in response to determining that the wireless communication device is an intended recipient of the DL data.

13. The wireless communication device of claim 11, wherein adjusting the backoff counter based on the determination comprises not adjusting the backoff counter in response to determining that the wireless communication device is not an intended recipient of the DL data.

14. The wireless communication device of claim 13, wherein execution of the processor-readable code causes the wireless communication device to perform operations further comprising:
stopping the countdown of the backoff counter in response to detecting the presence of the DL data; and
continuing, during a next medium access contention operation, the countdown of the backoff counter from where it was stopped.

15. The wireless communication device of claim 11, wherein initiating the countdown of the backoff counter comprises:
receiving an indication of a contention window size to be used for one or more UL medium access contention operations;
selecting a random backoff number from the indicated contention window size; and
setting an initial value of the backoff counter based on the selected random backoff number.

16. The wireless communication device of claim 15, wherein execution of the processor-readable code causes the wireless communication device to receive, from an access point (AP), one or more beacon frames including the indicated contention window size.

17. The wireless communication device of claim 16, wherein the indicated contention window size is proportional to a number of devices associated with the AP.

18. The wireless communication device of claim 15, wherein the indicated contention window size is based on one or more of a number of collisions on the shared wireless medium, an amount of traffic on the shared wireless medium, or a level of contention on the shared wireless medium.

19. The wireless communication device of claim 15, wherein the indicated contention window size is based on a relationship between DL throughput and UL throughput on the shared wireless medium.

20. A method for wireless communication performed by a wireless communication device, comprising:
receiving an indication of a contention window size to be used for one or more medium access contention operations, the indicated contention window size based on one or more of a number of collisions on the shared wireless medium, an amount of traffic on the shared wireless medium, or a level of contention on the shared wireless medium;
selecting a random backoff number from the indicated contention window size;
setting an initial value of the backoff counter based on the selected random backoff number; and
contending for medium access, based on a countdown of the backoff counter, to transmit uplink (UL) data on the shared wireless medium.

21. The method of claim 20, further comprising receiving one or more beacon frames transmitted from an access point (AP), wherein the indication is received in one or more of the beacon frames.

22. The method of claim 20, wherein contending for medium access comprises:
initiating the countdown of the backoff counter;
detecting a presence of downlink (DL) data on the shared wireless medium;
determining whether the wireless communication device is an intended recipient of the DL data; and
adjusting the backoff counter based on the determination.

23. The method of claim 22, wherein adjusting the backoff counter based on the determination comprises resetting the backoff counter to an initial value in response to determining that the wireless communication device is an intended recipient of the DL data.

24. The method of claim 22, wherein adjusting the backoff counter based on the determination comprises not adjusting the backoff counter in response to determining that the wireless communication device is not an intended recipient of the DL data.

25. The method of claim 22, further comprising:
stopping the countdown of the backoff counter in response to detecting the presence of the DL data; and
continuing, during a next medium access contention operation, the countdown of the backoff counter from where it was stopped.

26. A wireless communication device comprising:
at least one modem;
at least one processor communicatively coupled with the at least one modem; and
at least one memory communicatively coupled with the at least one processor and storing processor-readable code that, when executed by the at least one processor in conjunction with the at least one modem, is configured to perform operations comprising:
receiving an indication of a contention window size to be used for one or more medium access contention operations, the indicated contention window size based on one or more of a number of collisions on the shared wireless medium, an amount of traffic on the shared wireless medium, or a level of contention on the shared wireless medium;
selecting a random backoff number from the indicated contention window size;
setting an initial value of the backoff counter based on the selected random backoff number; and
contending for medium access, based on a countdown of the backoff counter, to transmit uplink (UL) data on the shared wireless medium.

27. The wireless communication device of claim 26, wherein execution of the processor-readable code causes the wireless communication device to receive one or more beacon frames transmitted from an access point (AP), wherein the indication is received in one or more of the beacon frames.

28. The wireless communication device of claim 26, wherein contending for medium access comprises:
initiating the countdown of the backoff counter;
detecting a presence of downlink (DL) data on the shared wireless medium;
determining whether the wireless communication device is an intended recipient of the DL data; and
adjusting the backoff counter based on the determination.

29. The wireless communication device of claim 28, wherein adjusting the backoff counter based on the determination comprises resetting the backoff counter to an initial value in response to determining that the wireless communication device is an intended recipient of the DL data.

30. The wireless communication device of claim 28, wherein adjusting the backoff counter based on the determination comprises not adjusting the backoff counter in response to determining that the wireless communication device is not an intended recipient of the DL data.
